(19) United States
(12) Patent Application Publication
(10) Pub. No.: US 2012/0176430 A1
(43) Pub. Date: Jul. 12, 2012

(54) CAPACITIVE LOAD DRIVE CIRCUIT AND INKJET HEAD DRIVE CIRCUIT

(75) Inventors: Noboru Nitta, Tagata-gun (JP); Tomohisa Yoshimaru, Yokohama-shi (JP)

(73) Assignee: TOSHIBA TEC KABUSHIKI KAISHA, Tokyo (JP)

(21) Appl. No.: 13/337,437

(22) Filed: Dec. 27, 2011

(30) Foreign Application Priority Data
Jan. 11, 2011 (JP) 2011-003159

(51) Int. Cl. B41J 29/38; H02J 7/00

(52) U.S. Cl. 347/9; 320/166

(57) ABSTRACT

According to one embodiment, a drive circuit of a capacitive load adjusts an impedance of at least one of the switches that are turned on to discharge a charge stored in the capacitive load back to a direct-current power source.

### CROSS-REFERENCE TO RELATED APPLICATIONS

This application is based upon and claims the benefit of priority from Japanese Patent Application No. 2011-003159, filed on Jan. 11, 2011; the entire contents of which are incorporated herein by reference.

### FIELD

Embodiments described herein relate generally to a capacitive load drive circuit for driving a capacitive load such as a piezoelectric element, and an inkjet head drive circuit.

### BACKGROUND

An inkjet head comprises a large number of capacitive loads such as piezoelectric elements as capacitive actuators for jetting ink. A drive circuit for driving these capacitive actuators therefore requires consideration of, for example, reducing the power consumption, suppressing noise generation, and suppressing an instantaneous rise in a drive voltage.

The operating efficiency of such capacitive actuators is influenced by temperature. The viscosity of ink used in an inkjet head varies with temperature. The viscosity of ink also varies with the kind of ink.

### BRIEF DESCRIPTION OF THE DRAWINGS

FIG. 1 is a diagram showing in section essential parts of an inkjet head according to a first embodiment;

FIG. 2 is a diagram showing each pressure chamber in FIG. 1 and its periphery from a different direction;

FIG. 3 is a diagram showing how one pressure chamber according to the first embodiment is expanded;

FIG. 4 is a diagram showing how the pressure chamber expanded as shown in FIG. 3 has restored to its steady state;

FIG. 5 is a diagram showing how the pressure chamber restored to its steady state as shown in FIG. 4 has contracted;

FIG. 6 is a diagram showing how the pressure chamber contracted as shown in FIG. 5 has restored to its steady state;

FIG. 7 is a block diagram showing the configuration of a drive circuit according to the first embodiment and its operation during the steady state;

FIG. 8 is a diagram showing the operation in step ST2 according to the first embodiment;

FIG. 9 is a diagram showing the operation in step ST3 according to the first embodiment;

FIG. 10 is a diagram showing the operation in step ST4 according to the first embodiment;

FIG. 11 is a diagram showing the operation in step ST5 according to the first embodiment;

FIG. 12 is a diagram showing the operation in step ST6 according to the first embodiment;

FIG. 13 is a diagram showing the operation in step ST7 according to the first embodiment;

FIG. 14 is a diagram showing the operation in step ST8 according to the first embodiment;

FIG. 15 is a diagram showing the operation in step ST9 according to the first embodiment;

FIG. 16 is a diagram showing the operation in step ST10 according to the first embodiment;

FIG. 17 is a diagram showing the operation in step ST11 according to the first embodiment;

FIG. 18 is a graph showing the change of the voltage of each unit in the drive circuit according to the first embodiment;

FIG. 19 is a block diagram showing the configuration of remaining buffer circuits other than a predetermined buffer circuit according to the first embodiment;

FIG. 20 is a block diagram showing the configuration of the predetermined buffer circuit according to the first embodiment;

FIG. 21 is a graph showing the output voltage of the buffer circuit shown in FIG. 20;

FIG. 22 is a graph showing, as a reference, the voltage change of each unit when the buffer circuit shown in FIG. 19 is used as the predetermined buffer circuit according to the first embodiment instead of the buffer circuit shown in FIG. 20;

FIG. 23 is a block diagram showing another example of the buffer circuit shown in FIG. 20 as a second embodiment;

FIG. 24 is a diagram showing a modification of essential parts in FIG. 23;

FIG. 25 is a diagram showing a modification of essential parts in FIG. 23;

FIG. 26 is a diagram showing a modification of essential parts in FIG. 23;

FIG. 27 is a diagram showing a modification of essential parts in FIG. 23;

FIG. 28 is a diagram showing a modification of essential parts in FIG. 23;

FIG. 29 is a block diagram showing another example of the buffer circuit shown in FIG. 20 as a third embodiment;

FIG. 30 is a diagram showing a modification of essential parts in FIG. 29;

FIG. 31 is a diagram showing a modification of essential parts in FIG. 29;

FIG. 32 is a block diagram showing another example of the buffer circuit shown in FIG. 20 as a fourth embodiment;

FIG. 33 is a block diagram showing another example of the buffer circuit shown in FIG. 20 as a fifth embodiment;

FIG. 34 is a block diagram showing a modification of the buffer circuit in the fourth modification;

FIG. 35 is a block diagram showing another example of the buffer circuit shown in FIG. 20 as a sixth embodiment;

FIG. 36 is a block diagram showing another example of the buffer circuit shown in FIG. 20 as a seventh embodiment; and

FIG. 37 is a diagram showing a modification of the buffer circuit in the seventh modification.

### DETAILED DESCRIPTION

In general, according to one embodiment, a drive circuit of a capacitive load includes a direct-current power source which outputs a direct-current voltage necessary to charge and discharge the capacitive load; switches which are connected between the direct-current power source and the capacitive load and which form a conduction path to charge and discharge the capacitive load; and an adjustment section which adjusts an impedance of at least one of the switches that are turned on to discharge a charge stored in the capacitive load back to the direct-current power source.

[1] A first embodiment is described.

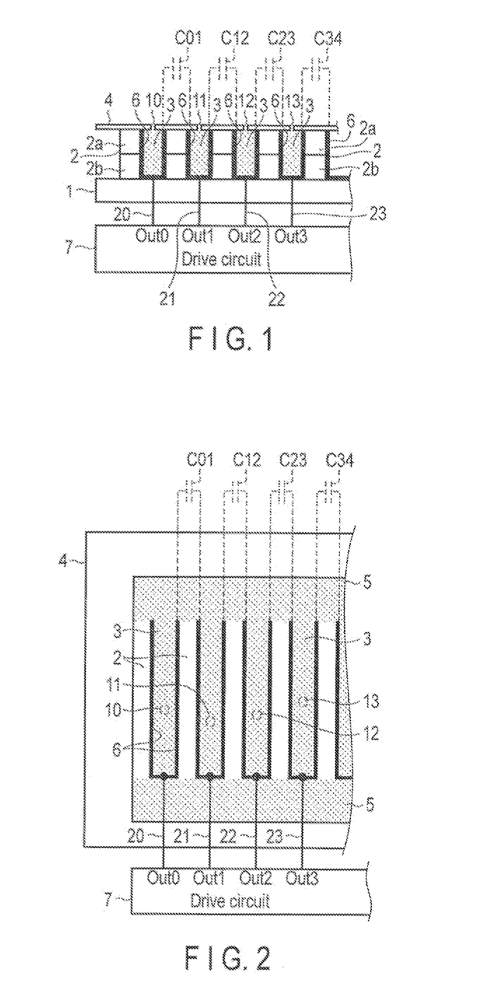

Essential parts of what is called a shear mode/shared wall type inkjet head are shown in FIG. 1 and FIG. 2. FIG. 1 is a diagram showing the essential parts in section. FIG. 2 is a diagram view showing part of FIG. 1 from a different direction.

Capacitive actuators 2 which are capacitive loads are arranged at predetermined intervals on the upper surface of a substrate 1. Each of these capacitive actuators (hereinafter abbreviated as actuators) 2 is shaped into a columnar shape by vertically bonding together piezoelectric elements 2a and 2b of, for example, lead zirconate titanate (PZT) so that their polarization directions are opposite to each other. A groove-shaped pressure chamber (also referred to as a channel) 3 is laid between the actuators 2.

A nozzle plate 4 is disposed over the actuators 2 and the pressure chambers 3. The nozzle plate 4 has nozzles 10, 11, 12, 13, . . . located to respectively correspond to the pressure chambers 3. Each of the pressure chambers 3 is in communication with an ink chamber 5. Ink in this ink chamber 5 flows into each of the pressure chambers 3. The leftmost nozzle 10 is a nozzle that does not jet the ink, and is called a dummy nozzle. Although not shown, the rightmost nozzle is also a dummy nozzle.

Electrodes 6 are disposed over the side surfaces of the actuators 2 and the bottom surfaces of the pressure chambers 3, respectively. The actuator 2 intervening between the electrodes 6 has a capacitance C01, C12, C23, C34, . . . . Hereinafter, for a clear explanation, the actuator 2 having the capacitance C01 is referred to as an actuator C01, the actuator 2 having the capacitance C12 is referred to as an actuator C12, the actuator 2 having the capacitance C23 is referred to as an actuator C23, and the actuator 2 having the capacitance C34 is referred to as an actuator C34.

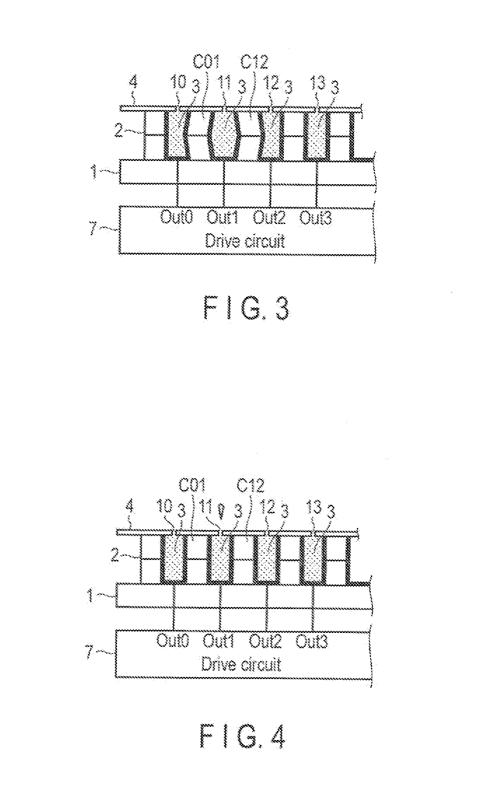

The electrodes 6 are connected to a drive circuit 7 via wiring lines 20, 21, 22, 23, . . . . The drive circuit 7 charges, discharges, and drives the actuators 2 such that the actuators C01, C12, C23, C34, . . . are repeatedly deformed and restored as shown in FIG. 3 to FIG. 6.

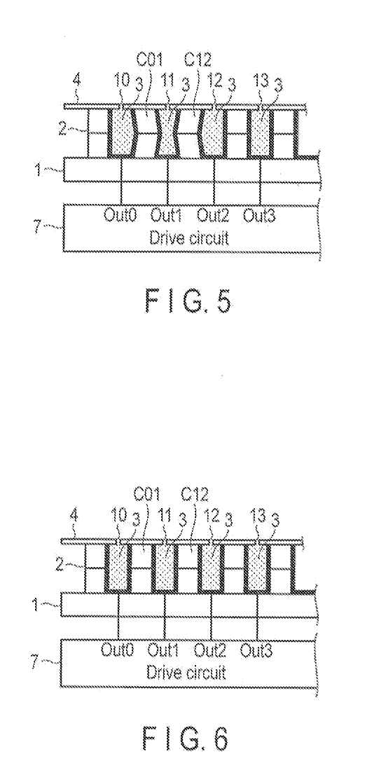

That is, the actuators C01 and C12 located on both sides of the pressure chamber 3 corresponding to the nozzle 11 are conducted in opposite directions such that the actuators C01 and C12 are deformed in a direction to separate from each other, as shown in FIG. 3. As a result, the pressure chamber 3 corresponding to the nozzle 11 is enlarged, and ink is introduced into the pressure chamber 3. The actuators C01 and C12 are then discharged and thereby restored to their steady state, as shown in FIG. 4. Accordingly, pressure in the pressure chamber 3 corresponding to the nozzle 11 rises, and the ink in the pressure chamber 3 is jetted from the nozzle 11. The actuators C01 and C12 are then conducted in a direction opposite to that in FIG. 3 and charged, and are thereby deformed in a direction to come closer to each other, as shown in FIG. 5. The actuators C01 and C12 are then discharged and thereby restored to their steady state, as shown in FIG. 6. The deformation in FIG. 5 and the restoration in FIG. 6 serve as damping to suppress a vibration generated in the ink in the pressure chamber 3 by the jetting.

The times respectively required for the deformation in FIG. 3, the restoration in FIG. 4, and the deformation in FIG. 5 are determined by the resonant frequency of the ink in the pressure chamber 3. The required times are equal when the loss of the vibration of the ink in the pressure chamber 3 is small.

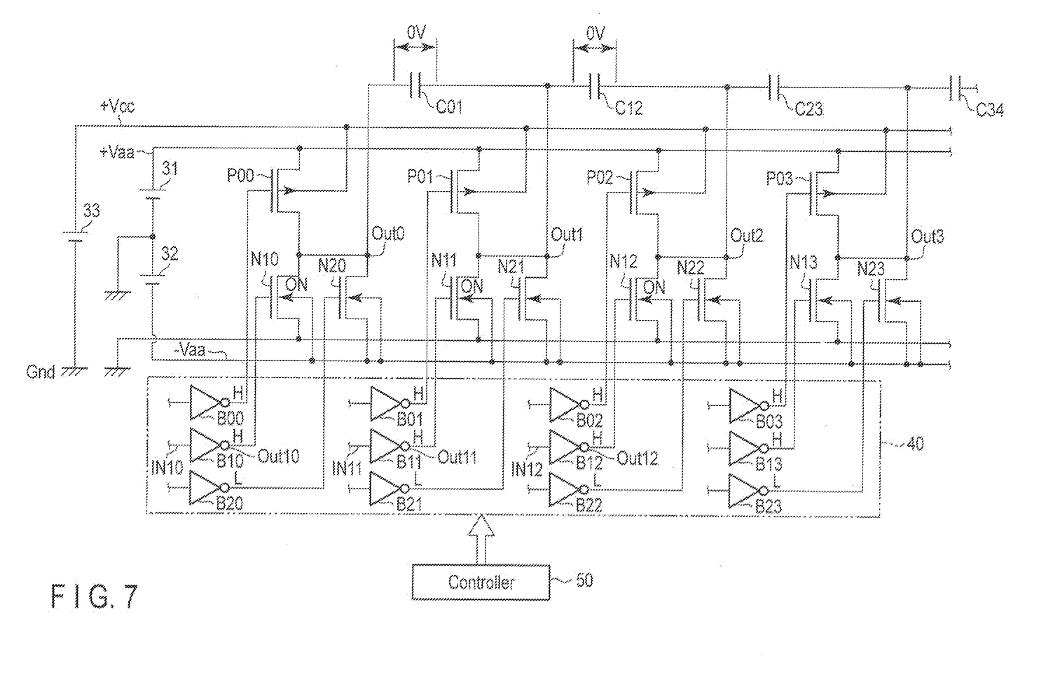

As shown in FIG. 7, a direct-current power source (first direct-current power source) 31 which outputs a direct-current voltage Vaa is connected in series with a direct-current power source (second direct-current power source) 32 which also outputs the direct-current voltage Vaa. That is, the negative side of the direct-current power source 31 is connected to the positive side of the direct-current power source 32. An interface point of the direct-current power sources 31 and 32 is grounded. The direct-current voltage Vaa output from the direct-current power sources 31 and 32 varies, for example, from 7 V to 18 V depending on conditions such as the kind and temperature of ink to be used and the temperature of the later-described actuators. If a drive voltage of 0 or ±Vaa is provided to the terminals of the actuator 2, a drive voltage of a maximum of ±2·Vaa is applied across the terminals of the actuator 2.

The negative side of a direct-current power source (third direct-current power source) 33 which outputs a direct-current voltage Vcc is grounded. The direct-current voltage Vcc is, for example, 24V which is higher than the direct-current voltage Vaa output from the direct-current power source 31, and serves as a bias voltage for a back gate of each MOS transistor described later, and as a drive voltage for each buffer circuit described later.

A series circuit between the source and drain of a P-type MOS transistor P00 such as a first P-type semiconductor element which is a switch and between the drain and source of an N-type MOS transistor N10 such as a first N-type semiconductor element which is a switch is connected between the positive side (+Vaa) of the direct-current power source 31 and the ground (±0). The drain and source of an N-type MOS transistor N20 such as a third N-type semiconductor element which is a switch are connected between an interface point (first interface point) of the P-type MOS transistor P00 and the N-type MOS transistor N10 and the negative side (−Vaa) of the direct-current power source 32.

The back gate of the P-type MOS transistor P00 is connected to the positive side (+Vcc) of the direct-current power source 33. The back gates of the N-type MOS transistors N10 and N20 are connected to the negative side (−Vaa) of the direct-current power source 32. The interface point (first interface point) of the P-type MOS transistor P00 and the N-type MOS transistor N10 serves as an output terminal Out0. The output terminal Out0 is connected to one end of the actuator C01.

The P-type MOS transistor P00 and the N-type MOS transistors N10 and N20 constitute a switch circuit (first switch circuit) which forms a charging/discharging conduction path for one end of the actuator C01. These MOS transistors P00, N10, and N20 are exclusively controlled to be on. When the P-type MOS transistor P00 is turned on, one end of the actuator C01 reaches the potential +Vaa. When the N-type MOS transistor N10 is turned on, one end of the actuator C01 reaches the ground potential. When the N-type MOS transistor N20 is turned on, one end of the actuator C01 reaches the potential −Vaa.

A series circuit between the source and drain of a P-type MOS transistor P01 such as a second P-type semiconductor element which is a switch and between the drain and source of an N-type MOS transistor N11 such as a second N-type semiconductor element which is a switch is connected between the positive side (+Vaa) of the direct-current power source 31 and the ground (±0). The drain and source of an N-type MOS transistor N21 such as a fourth N-type semiconductor element which is a switch are connected between an interface point (second interface point) of the P-type MOS transistor P01 and the N-type MOS transistor N11 and the negative side (−Vaa) of the direct-current power source 32.

The back gate of the P-type MOS transistor P01 is connected to the positive side (+Vcc) of the direct-current power source 33. The back gates of the N-type MOS transistors N11 and N21 are connected to the negative side (−Vaa) of the direct-current power source 32. The interface point (second interface point) of the P-type MOS transistor P01 and the N-type MOS transistor N11 serves as an output terminal Out1. The output terminal Out1 is connected to the other end of the actuator C01.

The P-type MOS transistor P01 and the N-type MOS transistors N11 and N21 constitute a switch circuit (second switch circuit) which forms a charging/discharging conduction path for the other end of the actuator C01. These MOS transistors P01, N11, and N21 are exclusively controlled to be on. When the P-type MOS transistor P01 is turned on, the other end of the actuator C01 reaches the potential +Vaa. When the N-type MOS transistor N11 is turned on, the other end of the actuator C01 reaches the ground potential. When the N-type MOS transistor N21 is turned on, the other end of the actuator C01 reaches the potential −Vaa.

The P-type MOS transistor 201 also functions as the first P-type semiconductor element for the adjoining actuator C12. The N-type MOS transistors N11 and N21 also function as the first N-type semiconductor element and the second N-type semiconductor element for the adjoining actuator C12. That is, a switch circuit comprising the P-type MOS transistor P01 and the N-type MOS transistors N11 and N21 also functions as a switch circuit (first switch circuit) which forms a charging/discharging conduction path for one end of the adjoining actuator C12. When the P-type MOS transistor P01 is turned on, one end of the actuator C12 reaches the potential +Vaa. When the N-type MOS transistor N11 is turned on, one end of the actuator C12 reaches the ground potential. When the N-type MOS transistor N21 is turned on, one end of the actuator C12 reaches the potential −Vaa.

A series circuit between the source and drain of a P-type MOS transistor P02 such as the second P-type semiconductor element which is a switch and between the drain and source of an N-type MOS transistor N12 such as the second N-type semiconductor element which is a switch is connected between the positive side (+Vaa) of the direct-current power source 31 and the ground (±0). The drain and source of an N-type MOS transistor N22 such as the fourth N-type semiconductor element which is a switch are connected between the interface point (second interface point) of the P-type MOS transistor P02 and the N-type MOS transistor N12 and the negative side (−Vaa) of the direct-current power source 32.

The back gate of the P-type MOS transistor P02 is connected to the positive side (+Vcc) of the direct-current power source 33. The back gates of the N-type MOS transistors N12 and N22 are connected to the negative side (−Vaa) of the direct-current power source 32. The interface point (second interface point) of the P-type MOS transistor P02 and the N-type MOS transistor N12 serves as an output terminal Out2. The output terminal Out2 is connected to the other end of the actuator C12.

The P-type MOS transistor P02 and the N-type MOS transistors N12 and N22 constitute a switch circuit (second switch circuit) which forms a charging/discharging conduction path for the other end of the actuator C12. These MOS transistors P02, N12, and N22 are exclusively controlled to be on. When the P-type MOS transistor P02 is turned on, the other end of the actuator C12 reaches the potential +Vaa. When the N-type MOS transistor N12 is turned on, the other end of the actuator C12 reaches the ground potential. When the N-type MOS transistor N22 is turned on, the other end of the actuator C12 reaches the potential −Vaa.

The P-type MOS transistor P02 also functions as the first P-type semiconductor element for the adjoining actuator C23. The N-type MOS transistors N12 and N22 also function as the first N-type semiconductor element and the second N-type semiconductor element for the adjoining actuator C23. That is, a switch circuit comprising the P-type MOS transistor P02 and the N-type MOS transistors N12 and N22 also functions as a switch circuit (first switch circuit) which forms a charging/discharging conduction path for one end of the adjoining actuator C23. When the P-type MOS transistor P02 is turned on, one end of the actuator C23 reaches the potential +Vaa. When the N-type MOS transistor N12 is turned on, one end of the actuator C23 reaches the ground potential. When the N-type MOS transistor N22 is turned on, one end of the actuator C23 reaches the potential −Vaa.

A series circuit between the source and drain of a P-type MOS transistor P03 such as the second P-type semiconductor element which is a switch and between the drain and source of an N-type MOS transistor N13 such as the second N-type semiconductor element which is a switch is connected between the positive side (+Vaa) of the direct-current power source 31 and the ground (±0). The drain and source of an N-type MOS transistor N23 such as the fourth N-type semiconductor element which is a switch are connected between the interface point (second interface point) of the P-type MOS transistor P03 and the N-type MOS transistor N13 and the negative side (−Vaa) of the direct-current power source 32.

The back gate of the P-type MOS transistor P03 is connected to the positive side (+Vcc) of the direct-current power source 33. The back gates of the N-type MOS transistors N13 and N23 are connected to the negative side (−Vaa) of the direct-current power source 32. The interface point (second interface point) of the P-type MOS transistor P03 and the N-type MOS transistor N13 serves as an output terminal Out3. The output terminal Out3 is connected to the other end of the actuator C23. The P-type MOS transistor P03 and the N-type MOS transistors N13 and N23 constitute a switch circuit (second switch circuit) which forms a charging/discharging conduction path for the other end of the actuator C23.

Similar switches are configured for the remaining actuators C34, . . . .

A buffer circuit block 40 is connected to the gate of each MOS transistor of each switch circuit. This buffer circuit block 40 comprises buffer circuits B00, B10, B20, B01, B11, B21, B02, B12, B22, B03, B13, B23, . . . connected to the gates of the respective MOS transistors. An external controller 50 is connected to the buffer circuit block 40. The controller 50 outputs control signals for selectively switching on and off the MOS transistors to charge and discharge the actuators C01, C12, C23, C34, . . . . Each buffer circuit of the buffer circuit block 40 supplies the gate of each MOS transistor with a drive signal corresponding to the control signal output from the controller 50.

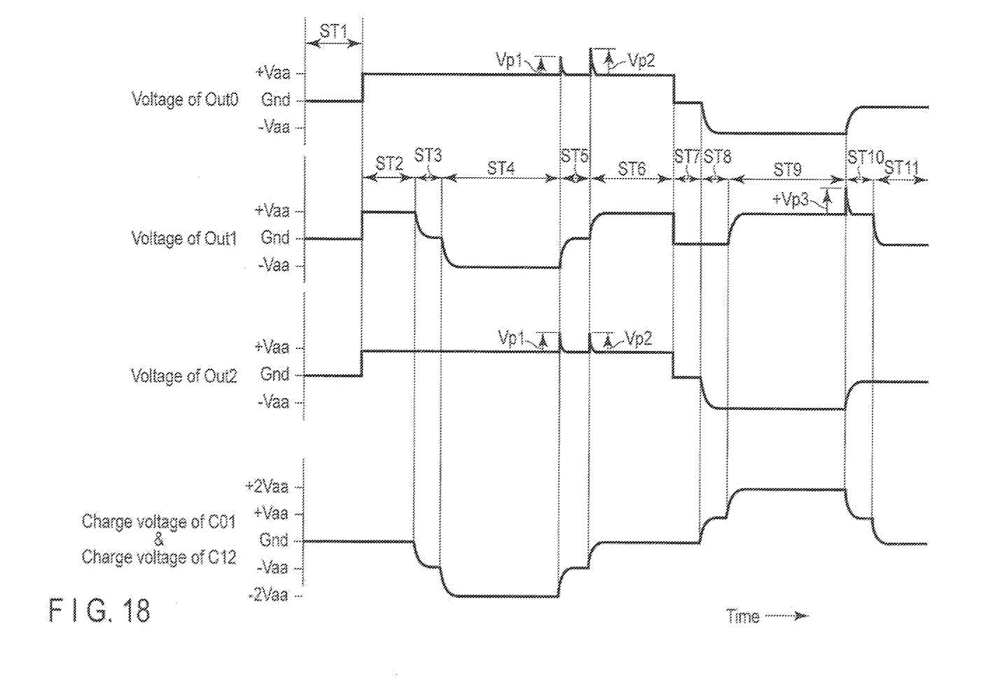

The operation of the drive circuit 7 is shown in FIG. 7 to FIG. 17. The changes of the voltage in each unit of the drive circuit 7 are shown as steps ST1 to ST11 in FIG. 18.

As the explanations for the operations of all the actuators would be long. Therefore, the driving of the actuators C01 and C12 for jetting ink from the nozzle 11 is mainly described.

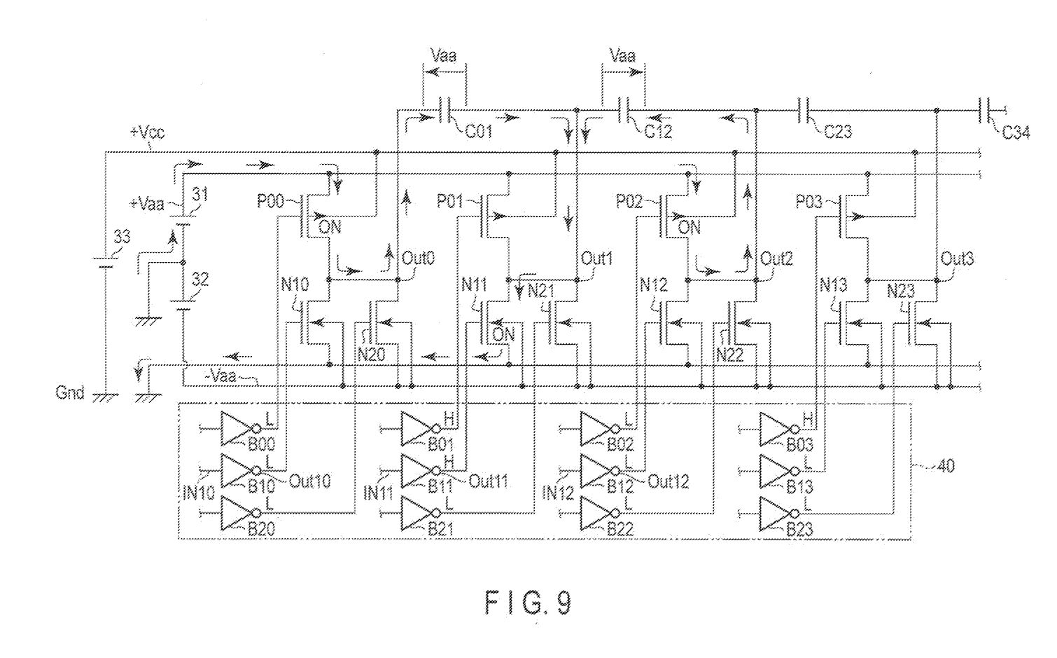

A negative direction in a lowermost voltage waveform in FIG. 18 corresponds to a direction in which the potential of the output terminal Out1 corresponding to the nozzle 11 for jetting ink is relatively negative. The actuators C01 and C12 comprise piezoelectric elements which are polarized to, when a voltage is applied in the above-mentioned direction, deform in a direction to expand the pressure chamber 3 corresponding to the nozzle 11. The directions of arrows provided between both ends of the actuator C01 and between both ends of the actuator C12 in FIGS. 9, 10, 11, 14, 15, and 16 represent the directions of charging voltages.

First, in step ST1, the MOS transistors N10, N11, N12, and N13 are turned on, and the other MOS transistors are turned off, as shown in FIG. 7. In this case, the voltages at both ends of the actuators C01 and C12 are ground voltages. Thus, the actuators C01 and C12 are not charged.

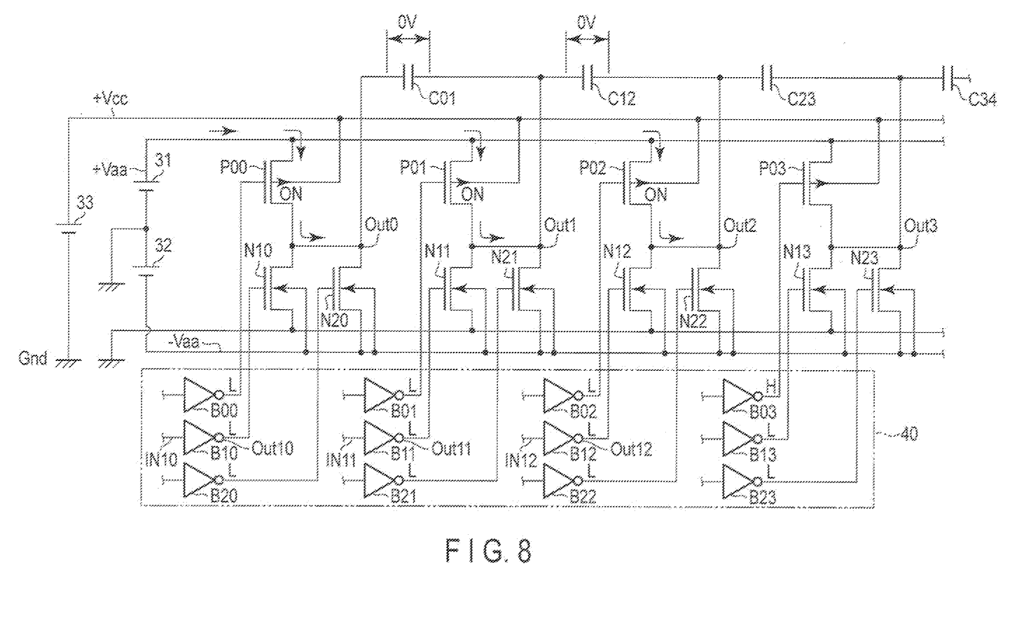

In step ST2, the MOS transistors N10, N11, N12, and N13 are turned off, and the MOS transistors P00, P01, and P02 are turned on, as shown in FIG. 8. In this case, the voltage +Vaa is output from the output terminals Out0, Out1, and Out2, and the potentials at both ends of the actuators C01 and C12 become equal. Thus, the actuators C01 and C12 are not charged.

In step ST3, the MOS transistors P00 and P02 remain on, the MOS transistor P01 is turned off, and the MOS transistor N11 is turned on, as shown in FIG. 9. In this case, the output terminals Out0 and Out2 remain at the potential +Vaa, and the output terminal Out1 drops to the ground potential (zero) from the potential +Vaa. A potential difference between the output terminal Out0 and the output terminal Out1 is applied to the actuator C01, and a potential difference between the output terminal Out2 and the output terminal Out1 is applied to the actuator C12. At the same time, the actuators C01 and C12 are therefore charged with the voltage −Vaa.

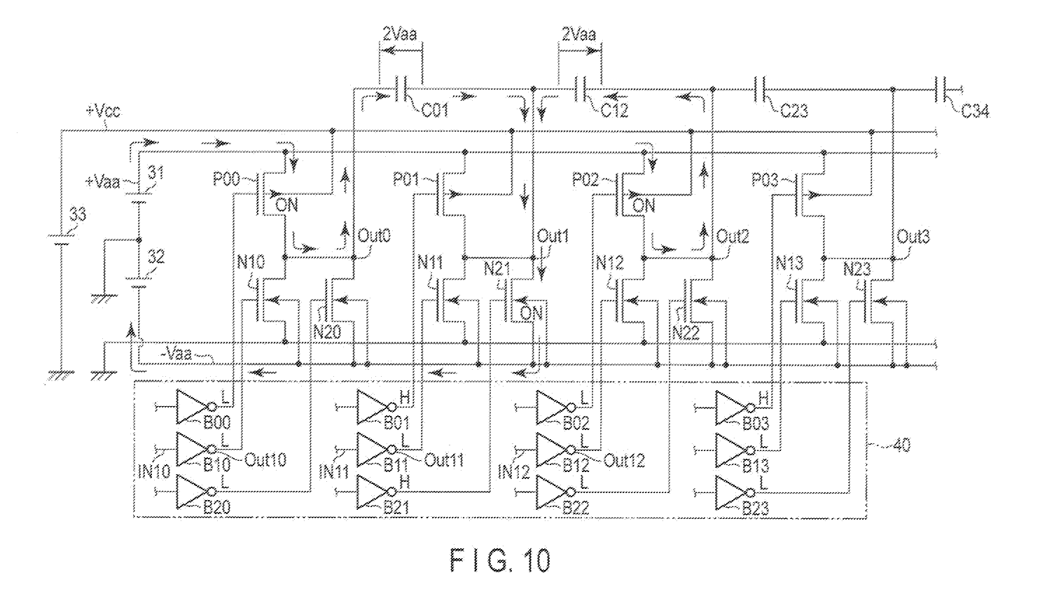

In step ST4, the MOS transistors P00 and P02 remain on, the MOS transistor N11 is turned off, and the MOS transistor N21 is turned on, as shown in FIG. 10. In this case, the output terminals Out0 and Out2 remain at the potential +Vaa, and the output terminal Out1 drops to the potential −Vaa. A potential difference between the output terminal Out0 and the output terminal Out1 is applied to the actuator C01, and a potential difference between the output voltage of the output terminal Out2 and the output terminal Out1 is applied to the actuator C12. At the same time, the actuators C01 and C12 are therefore further charged to reach a voltage −2·Vaa.

The charging in steps ST3 and ST4 deforms the actuators C01 and C12 in a direction to separate from each other, as shown in FIG. 3. As a result of this deformation, the pressure chamber 3 corresponding to the nozzle 11 is enlarged, and ink is introduced into the pressure chamber 3.

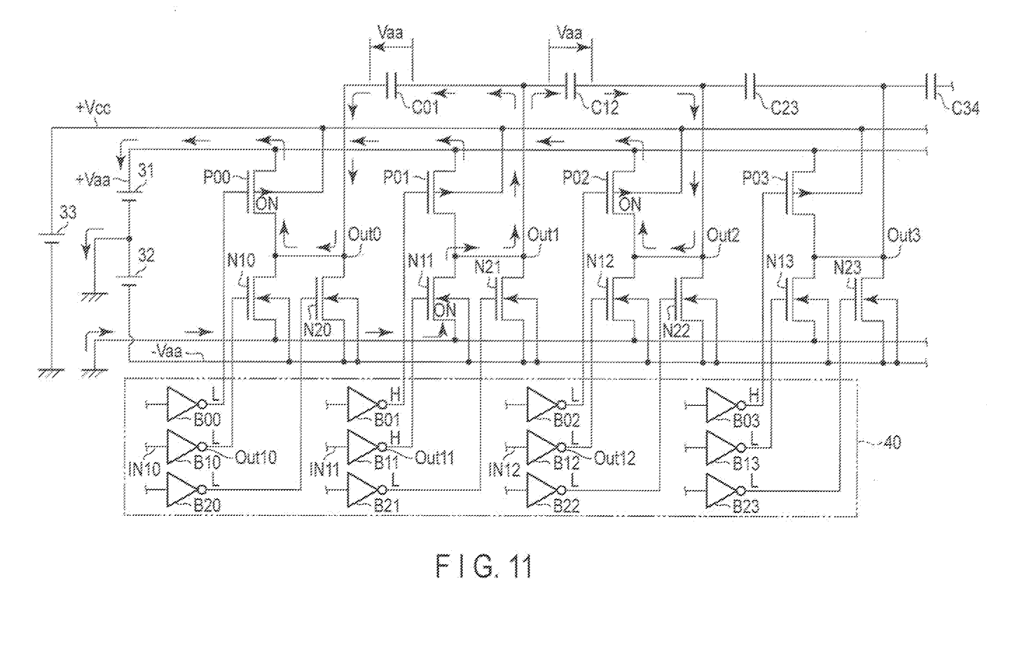

In step ST5, the MOS transistors P00 and P02 remain on, the MOS transistor N21 is turned off, and the MOS transistor N11 is turned on, as shown in FIG. 11. In this case, one end (+side) of the actuator C01 charged with the voltage −2·Vaa is conducted to the positive side (+Vaa) of the direct-current power source 31 via the MOS transistor P00, and the other end (−side) of the actuator C01 is conducted to the ground via the MOS transistor N11. The absolute value of the voltage −2·Vaa with which the actuator C01 is charged is higher than the voltage Vaa output by the direct-current power source 31. Therefore, a charge stored in the actuator C01 is discharged toward the direct-current power source 31.

Similarly, the other end (+side) of the actuator C12 charged with the voltage −2·Vaa is conducted to the positive side (+Vaa) of the direct-current power source 31 via the MOS transistor P02, and one end (−side) of the actuator C12 is conducted to the ground via the MOS transistor N11. The absolute value of the voltage −2·Vaa with which the actuator C12 is charged is higher than the voltage Vaa output by the direct-current power source 31. Therefore, a charge stored in the actuator C12 is discharged toward the direct-current power source 31. After these discharges, the charging voltages of the actuators C01 and C12 change from −2·Vaa to −Vaa.

At the start of the discharge in step ST5, the potential of the output terminal Out0 connected to one end of the actuator C01 instantaneously rises by Vp1, and the potential of the output terminal Out2 connected to the other end of the actuator C12 also instantaneously rises by Vp1. This instantaneous voltage rise Vp1 is hereinafter referred to as a peak voltage Vp1.

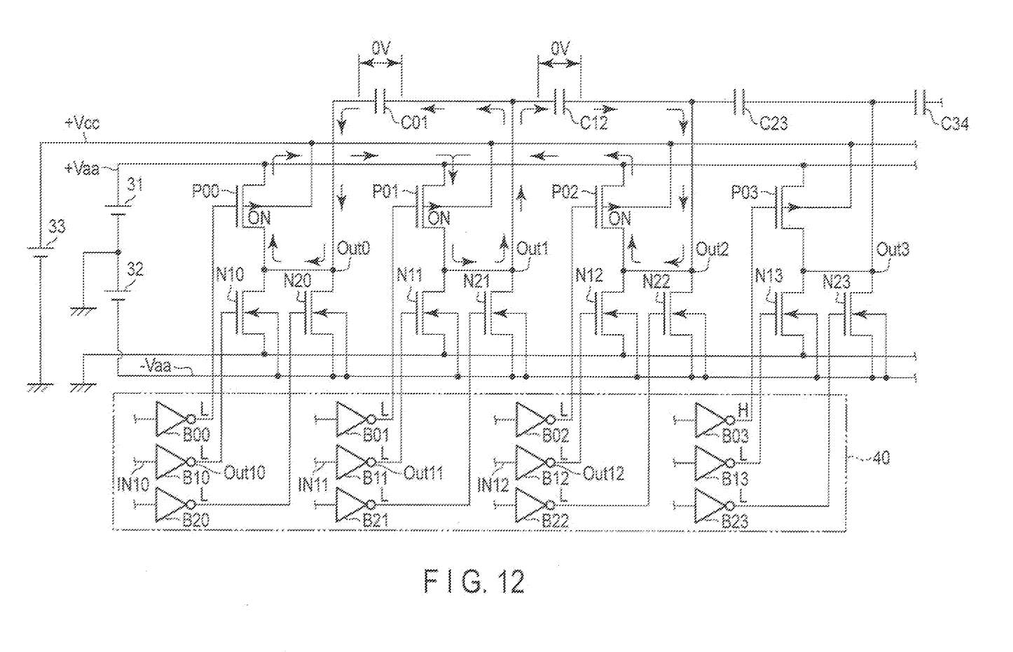

In step ST6, the MOS transistors P00 and P02 remain on, the MOS transistor N11 is turned off, and the MOS transistor P01 is turned on, as shown in FIG. 12. In this case, a short-circuit path where one end of the actuator C01 in which the charging voltage Vaa remains is conducted to the other end of the actuator C01 via the MOS transistors P00 and P01 is formed, and the discharge of the actuator C01 is continued through this short-circuit path. Similarly, a short-circuit path where the other end of the actuator C12 in which the charging voltage Vaa remains is conducted to one end of the actuator C12 via the MOS transistors P02 and P01 is formed, and the discharge of the actuator C12 is continued through this short-circuit path. After these discharges, the charging voltages of the actuators C01 and C12 change from −Vaa to 0.

At the start of the discharge in step ST6, the potential of the output terminal Out0 connected to one end of the actuator C01 instantaneously rises by Vp2, and the potential of the output terminal Out2 connected to the other end of the actuator C12 also instantaneously rises by Vp2. This instantaneous voltage rise Vp2 is hereinafter referred to as a peak voltage Vp2.

As a result of the discharges in steps ST5 and ST6, the actuators C01 and C12 are restored to their steady state, as shown in FIG. 4. In response to this restoration, the pressure in the pressure chamber 3 corresponding to the nozzle 11 rises, and the ink in the pressure chamber 3 is jetted from the nozzle 11.

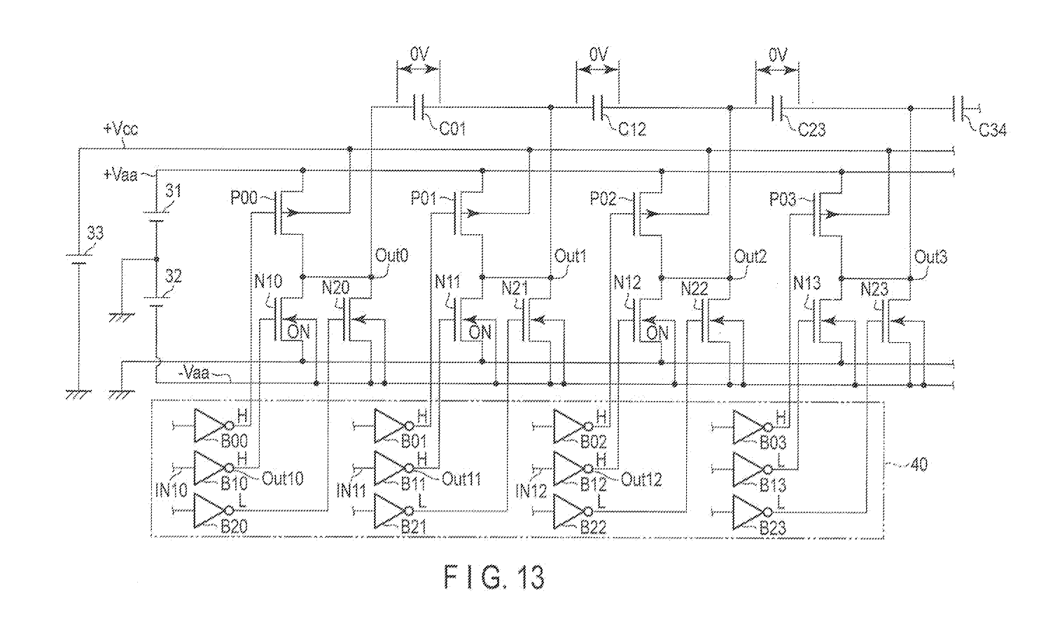

In step ST7, the MOS transistors P00, P01, and P02 are turned off, and the MOS transistors N10, N11, and N12 are turned on, as shown in FIG. 13. The output voltages of the output terminals Out0, Out1, and Out2 become the ground potentials. At the same time, the voltages at both ends of the actuators C01 and C12 remain at 0, and the actuators C01 and C12 are not charged.

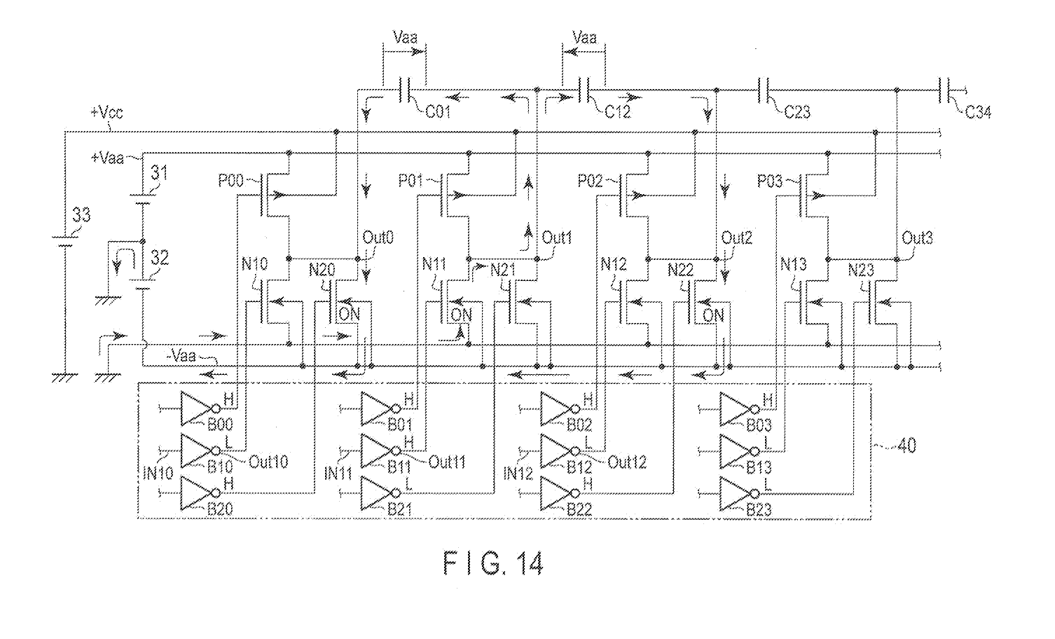

In step ST8, the MOS transistor N11 remains on, the MOS transistors N10 and N12 are turned off, and the MOS transistors N20 and N22 are turned on, as shown in FIG. 14. In this case, the output terminal Out1 remains at the ground potential, and the output terminals Out0 and Out2 reach the potential −Vaa. A potential difference between the output terminal Out1 and the output terminal Out0 is applied to the actuator 001, and a potential difference between the output terminal Out1 and the output terminal Out2 is applied to the actuator C12. Accordingly, the actuators C01 and C12 are charged with the voltage +Vaa.

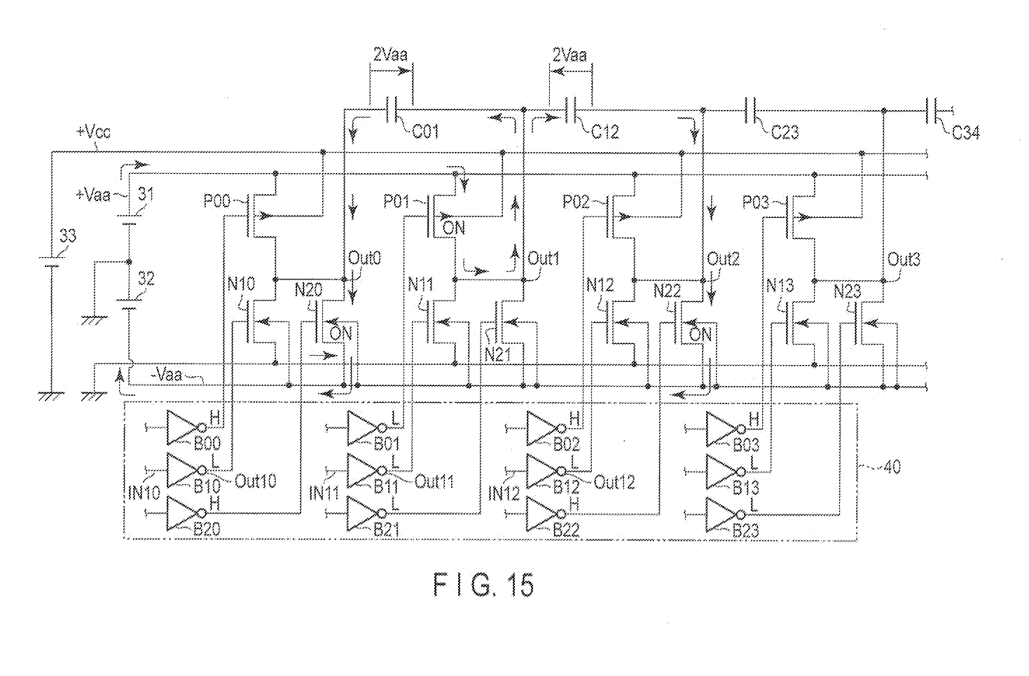

In step ST9, the MOS transistors N20 and N22 remain on, the MOS transistor N11 is turned off, and the MOS transistor 201 is turned on, as shown in FIG. 15. In this case, the output voltages of the output terminals Out0 and Out2 remain at −Vaa, and the output terminal Out1 reaches the potential +Vaa. A potential difference between the output terminal Out1 and the output terminal Out0 is applied to the actuator C01, and a potential difference between the output terminal Out1 and the, output terminal Out2 is applied to the actuator C12. Accordingly, the actuators C01 and C12 are further charged to reach a voltage +2·Vaa.

The charging in steps ST8 and ST9 deforms the actuators C01 and C12 in a direction to come closer to each other, as shown in FIG. 5.

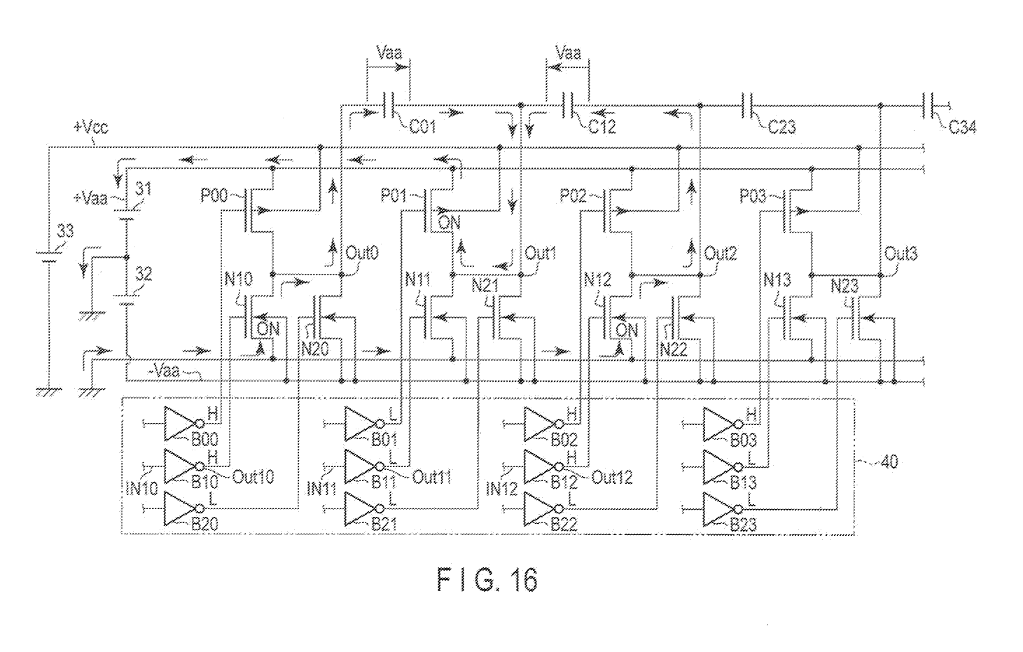

In step ST10, the MOS transistor 201 remains on, the MOS transistors N20 and N22 are turned off, and the MOS transistors N10 and N11 are turned on, as shown in FIG. 16. In this case, the other end (+side) of the actuator C01 charged with the voltage +2·Vaa is conducted to the positive side (+Vaa) of the direct-current power source 31 via the MOS transistor P01, and one end (−side) of the actuator C01 is conducted to the ground via the MOS transistor N10. The absolute value of the voltage +2·Vaa with which the actuator C12 is charged is higher than the voltage Vaa output by the direct-current power source 31. Therefore, a charge stored in the actuator C12 is discharged toward the direct-current power source 31. Similarly, one end (+side) of the actuator C12 charged with the voltage +2·Vaa is conducted to the positive side (+Vaa) of the direct-current power source 31 via the MOS transistor P01, and the other end (−side) of the actuator C12 is conducted to the ground via the MOS transistor N12. The absolute value of the voltage +2·Vaa with which the actuator C12 is charged is higher than the voltage Vaa output by the direct-current power source 31. Therefore, a charge stored in the actuator C12 is discharged toward the direct-current power source 31. After these discharges, the charging voltages of the actuators C01 and C12 change from +2·Vaa to +Vaa.

At the start of the discharge in step ST10, the potential of the output terminal Out1 connected to the other end of the actuator C01 and one end of the actuator C12 instantaneously rises by Vp3. This instantaneous voltage rise Vp3 is hereinafter referred to as a peak voltage Vp3.

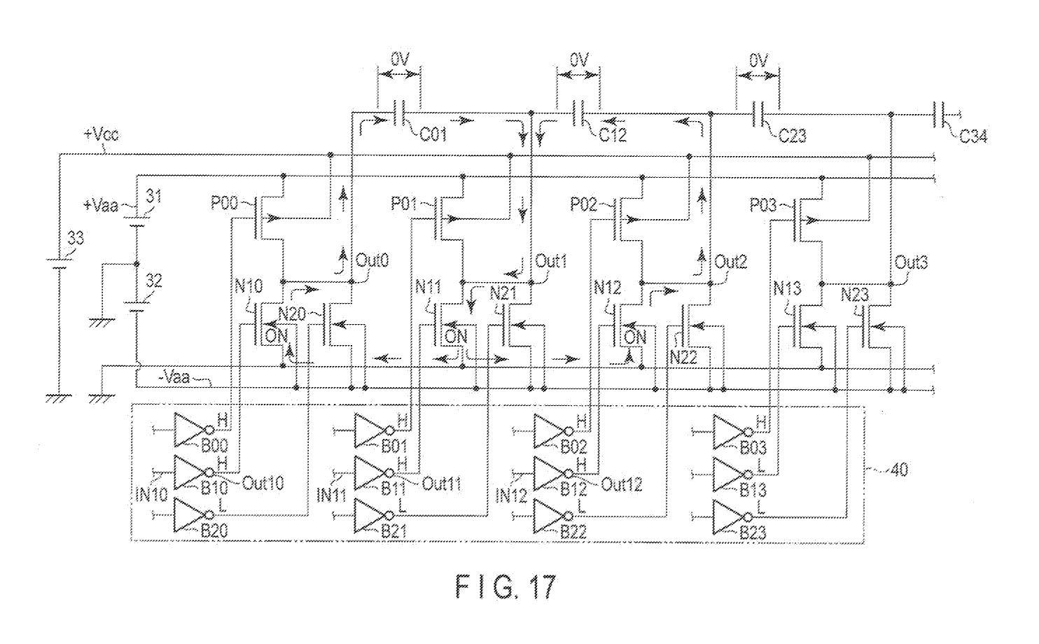

In step ST11, the MOS transistors N10 and N12 remain on, the MOS transistor P01 is turned off, and the MOS transistor N11 is turned on, as shown in FIG. 17. In this case, a short-circuit path where the other end of the actuator C01 in which the charging voltage Vaa remains is conducted to one end of the actuator C01 via the MOS transistors N11 and N10 is formed, and the discharge of the actuator C01 is continued through this short-circuit path. Similarly, a short-circuit path where one end of the actuator C12 in which the charging voltage Vaa remains is conducted to the other end of the actuator C12 via the MOS transistors N11 and N12 is formed, and the discharge of the actuator C12 is continued. After these discharges, the charging voltages of the actuators C01 and C12 change from +Vaa to 0.

As a result of the discharges in steps ST10 and ST11, the actuators C01 and 012 are restored to their steady state, as shown in FIG. 6.

The deformation in step ST9 and the shape restoration in steps ST10 and ST11 are damping to suppress a vibration generated in the ink in the pressure chamber 3 by the jetting.

Two stages of charging are performed in each of steps ST3 and ST4 and each of steps ST8 and ST9, and two stages of discharging are performed in each of steps ST5 and ST6 and each of steps ST10 and ST11. The two stages of charging and the two stages of discharging enable the reduction of power consumption. The principle that enables the reduction of consumption by separate charging and discharging steps is described in, for example, Jpn. Pat. Appln. KOKAI Publication No. 2000-185400.

In steps ST2 and ST7, the actuators are not charged and discharged, and the potentials of the terminals of the actuators are determined. In steps ST2 and ST7 where the actuators C01 and C12 are not charged and discharged, a load is light, so that it is preferable to take measures against noise. A technique described in Jpn. Pat. Appln. KOKAI Publication No. 2001-10043 is known as an example of a noise countermeasure, and this technique may therefore be combined with the present embodiment.

[The Buffer Circuits are Described]

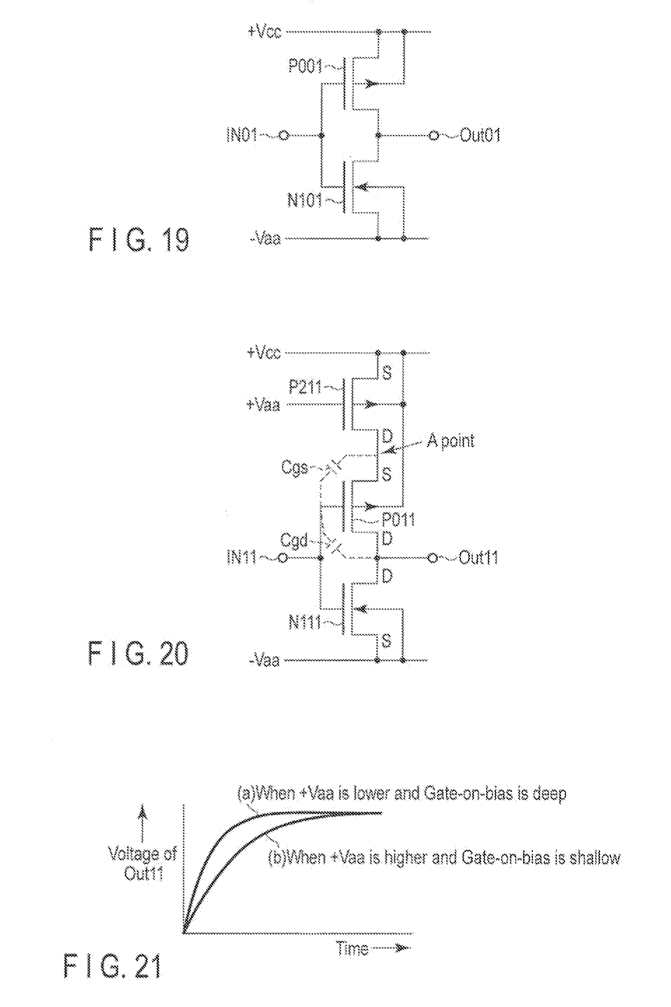

Among the buffer circuits in the buffer circuit block 40, each of the buffer circuits corresponding to the remaining MOS transistors other than the grounded N-type MOS transistors N10, N11, N12, N13, . . . has the configuration shown in FIG. 19. FIG. 19 shows an example buffer circuit B01 for driving the gate of the P-type MOS transistor P01.

The buffer circuit B01 connects the series circuit between the source and drain of a P-type MOS transistor P001 such as a P-type semiconductor element and between the drain and source of an N-type MOS transistor N101 such as the N-type semiconductor element to a point between the positive side (+Vcc) of the direct-current power source 33 and the negative side (−Vaa) of the direct-current power source 32, connects the back gate of the P-type MOS transistor P001 to the positive side (+Vcc) of the direct-current power source 33, and connects the back gate of the N-type MOS transistor N101 to the negative side (−Vaa) of the direct-current power source 32. That is, a complementary pair configuration of the P-type MOS transistor P001 and the N-type MOS transistor N101 is used. The gate of the P-type MOS transistor P001 and the gate of the N-type MOS transistor N101 serve as an input terminal IN01. The control signal supplied from the controller 50 is brought into the input terminal IN01. An interface point of the P-type MOS transistor P001 and the N-type MOS transistor N101 is an output terminal Out01. A drive signal is output from the output terminal Out01.

On the other hand, the configurations of the buffer circuits B10, B11, B12, B13, . . . which output drive signals to the grounded N-type MOS transistors N10, N11, N12, N13, . . . are shown in FIG. 20. FIG. 20 shows an example buffer circuit B11 for driving the gate of the N-type MOS transistor N11.

The buffer circuit B11 comprises a P-type MOS transistor P211 such as a P-type semiconductor element which is an adjustment section, in addition to the basic configuration in FIG. 19. The P-type MOS transistor P211 is inserted and connected between the positive side (+Vcc) of the direct-current power source 33 and the series circuit between a P-type MOS transistor P011 and an N-type MOS transistor N111. The gate of the P-type MOS transistor P211 is connected to the positive side (+Vaa) of the direct-current power source 31.

When the output voltage Vaa of the direct-current power source 31 is high, the P-type MOS transistor P211 slows down the rising of the voltage of a drive signal output to turn on the N-type MOS transistor corresponding to the buffer circuit B11. When the output voltage Vaa of the direct-current power source 31 is low, the P-type MOS transistor 2211 speeds up the rising of the voltage.

In general, all the MOS transistors and all the buffer circuits are formed on the substrate of one integrated circuit. The potential of this integrated circuit substrate is −Vaa. The potential of an island where the P-type MOS transistors are located is +Vcc.

[The Peak Voltages are Described]

The peak voltage Vp1 generated at the start of the discharge in step ST5, the peak voltage Vp2 generated at the start of the discharge in step ST6, and the peak voltage Vp3 generated at the start of the discharge in step ST10 are described.

The discharges in steps ST5 and ST10 are operations for returning the charges stored in the actuators C01 and C12 toward the positive side of the direct-current power source 31. If the charge is returned toward the positive side of the direct-current power source 31, the returned charge and the charge which is supplied from the positive side of the direct-current power source 31 to charge the actuators C01 and C12 are offset, so that power consumption can be reduced. The discharge in step ST6 is an operation for discharging the charges in the actuators C01 and C12 remaining after discharging in step ST5 to 0.

At the start of the discharges in ST5, ST6, and ST10, the peak voltages Vp1, Vp2, and Vp3, which are instantaneous voltage rises, are generated in the output terminals Out0, Out1, and Out2.

In step ST5, the peak voltage Vp1 is generated in each of the output terminals Out0 and Out2. In this case, the maximum voltage of each of the output terminals Out0 and Out2 is “Vp1+Vaa” on the basis of the ground potential. The potential of this maximum voltage is hereinafter referred to as a peak potential Vp1a.

In step ST6, the peak voltage Vp2 is generated in each of the output terminals Out0 and Out2. In this case, the maximum voltage of each of the output terminals Out0 and Out2 is “Vp2+Vaa” on the basis of the ground potential. The potential of this maximum voltage is hereinafter referred to as a peak potential Vp2a.

In step ST10, the peak voltage Vp3 is generated in the output terminal Out1. In this case, the maximum voltage of the output terminal Out1 is “Vp3+Vaa” on the basis of the ground potential. The potential of this maximum voltage is hereinafter referred to as a peak potential Vp3a.

If one of the peak potentials Vp1a, Vp2a, and Vp3a is higher than a value (=Vcc+Vf) obtained by adding a predetermined value Vf to the bias voltage Vcc for the back gates of the P-type MOS transistors P00, P01, P02, P03, . . . , a current runs through the back gates of the P-type MOS transistors P00, P01, P02, P03, . . . , which leads to the drive circuit 7 operating improperly. The predetermined value Vf is a forward voltage of a PN junction, and is generally about 0.6 V in the case of a silicon semiconductor.

Therefore, attention is needed to prevent the peak potentials Vp1a, Vp2a, and Vp3a from exceeding “Vcc+Vf”.

The peak potentials Vp1a, Vp2a, and Vp3a are values obtained by adding the voltage Vaa supplied from the direct-current power source 31 to the peak voltages Vp1, Vp2, and Vp3, and are therefore higher when the voltage Vaa supplied from the direct-current power source 31 is higher. The peak voltages Vp1, Vp2, and Vp3 are proportional to the difference between the absolute value 2·Vaa of the voltage with which the actuators C01 and C12 are charged and the voltage Vaa supplied from the direct-current power source 31, and are therefore also higher when Vaa is higher. That is, when the drive voltage ±Vaa supplied from the direct-current power sources 31 and 32 is higher, the values of the peak potentials Vp1a, Vp2a, and Vp3a are higher. Thus, in order to keep the peak potentials Vp1a, Vp2a, and Vp3a within “Vcc+Vf”, the drive voltage ±Vaa supplied from the direct-current power sources 31 and 32 has to be limited so that the drive voltage ±Vaa may not be extremely high. However, the drive voltage ±Vaa is preferably available in a widest possible range. If the peak voltages Vp1, Vp2, and Vp3 can be decreased, it is possible to extend the range of the drive voltage ±Vaa to a higher level while keeping the peak potentials Vp1a, Vp2a, and Vp3a within “Vcc+Vf”.

In order to properly jet ink regardless of conditions such as the temperature, the viscosity of ink, and the difference of efficiency of the individual actuators, properly selecting a drive voltage in accordance with these conditions is effective. Thus, the actuators C01 and 012 are preferably drivable by a wide range of drive voltages. The peak voltages Vp1, Vp2, and Vp3 are preferably suppressed for a wider range of the drive voltage ±Vaa.

[The Relation Between an Operating Speed, Conduction Impedance, and the Peak Voltage is Described]

The output voltage of the buffer circuit shown in FIG. 19 swings between the potential +Vcc and the potential −Vaa across the ground potential serving as a 0 reference. While the potential +Vcc is fixed at 24 V, the potential −Vaa is the negative potential of the direct-current power source 32 and is therefore a voltage selected from −7 V to −18 V in accordance with conditions such as the temperature, the viscosity of ink, and the difference of efficiency of the individual actuators. The voltage to be selected varies depending on these conditions, so that the drive circuit has to be adaptable to any voltage ranging between −7 V and −18 V.

Here, the P-type MOS transistors P00, P01, P02, P03, . . . and the buffer circuit which supplies the drive signals to these P-type MOS transistors are considered.

When the drive voltage ±Vaa is ±18V and high, the gate voltages of the P-type MOS transistors P00, P01, P02, P03, . . . swing to −18V in an on-state, and the gate ON bias is a maximum of 36 V and sufficiently deep. If the gate ON bias is deep, the conduction impedance of the P-type MOS transistors P00, P01, P02, P03, . . . in an on-state is low, and the operating speed of the P-type MOS transistors P00, P01, P02, P03, . . . is high.

When the drive voltage ±Vaa is ±7V and low on the other hand, the gate voltages of the P-type MOS transistors P00, P01, P02, P03, . . . swing to −7V in an on-state, and the gate ON bias is a maximum of 14V and shallow. If the gate ON bias is shallow, the conduction impedance of the P-type MOS transistors P00, P01, P02, P03, . . . in, an on-state is high, and the operating speed of the P-type MOS transistors P00, P01, P02, P03, . . . is low. The conduction impedance and operating speed of the P-type MOS transistors P00, P01, P02, P03, . . . influence the intensity of the peak voltage Vp2 generated in the output terminals Out0 and Out2 in step ST6.

The intensity of the peak voltage Vp2 is determined by the ratio of the conduction impedance of the P-type MOS transistor P01 in an on-state to the conduction impedance of the P-type MOS transistors P00 and P02 in an on-state. When the conduction impedance of the P-type MOS transistor P01 located on the downstream side of a discharge current in an on-state is lower than the conduction impedance of the P-type MOS transistors P00 and P02 located on the upstream side of the discharge current in an on-state, the peak voltage Vp2 generated in the output terminals Out0 and Out2 is higher. This concerns the operating speed of the P01 as described next. Here, the upstream side of the discharge current means the side where each peak voltage is generated, and the downstream side means the opposite side, that is, the ground side.

The P-type MOS transistors P00, P01, and P02 are the same size, and are turned on by the same level of gate ON bias. The conduction impedance of each of the P-type MOS transistors P00 and P02 and the conduction impedance of the P-type MOS transistor P01 are different from each other in the beginning of step ST6. While the P-type MOS transistors P00 and P02 continue to be in the on-state from step ST5 to step ST6, the P-type MOS transistor P01 changes from the off-state to the on-state in the beginning of step ST6. If the operating speed of the P01 is low, the conduction impedance of the P01 is in the process of changing from the off-state to the on-state and is therefore still high when the peak voltage Vp2 is generated in the beginning of step ST6, so that the peak voltage Vp2 is low. In contrast, if the operating speed of the P01 is high, the conduction impedance of the P01 is already close to the conduction impedance of the P00 and P02 when the peak voltage Vp2 is generated in the beginning of step ST6, so that the peak voltage Vp2 is higher than when the operating speed of the P01 is low.

When the configuration of the buffer circuit shown in FIG. 19 is also used in the buffer circuits 310, B11, 312, B13, . . . corresponding to the N-type MOS transistors N10, N11, N12, N13, . . . , the N-type MOS transistors N10, N11, N12, N13, . . . operate as follows.

The gate voltages of the N-type MOS transistors N10, N11, N12, N13, . . . swing to +24 V regardless of the intensity of the drive voltage ±Vaa. The gate ON bias thereof is a maximum of 24 V and deep. If the gate ON bias is deep, the conduction impedance of the N-type MOS transistors N10, N11, N12, N13, . . . is low, and the operating speed thereof is low. The conduction impedance and operating speed of the N-type MOS transistors N10, N11, N12, N13, . . . influence the intensity of the peak voltage Vp1 generated in the output terminals Out0 and Out2 in step ST5.

The intensity of the peak voltage Vp1 is determined by the ratio of the conduction impedance of the N-type MOS transistor N11 in an on-state to the conduction impedance of each of the P-type MOS transistors P00 and P02 in an on-state. When the conduction impedance of the N-type MOS transistor N11 located on the downstream side of a discharge current in an on-state is lower than the conduction impedance of the P-type MOS transistors P00 and P02 located on the upstream side of the discharge current in an on-state, the peak voltage Vp1 generated in the output terminals Out0 and Out2 is higher. This concerns the operating speed of the N11 as described next.

While the P-type MOS transistors P00 and P02 continue to be in the on-state from step ST4 to step ST5, the N-type MOS transistor Nil changes from the off-state to the on-state in the beginning of step ST5. If the operating speed of the N11 is low, the conduction impedance of the N11 is in the process of changing from the off-state to the on-state and is therefore still high when the peak voltage Vp1 is generated in the beginning of step ST5, so that the peak voltage Vp1 is low. In contrast, if the operating speed of the N11 is high, the conduction impedance of the N11 is already low when the peak voltage Vp1 is generated in the beginning of step ST5, so that the peak voltage Vp1 is higher than when the operating speed is low.

The operating speed of the N-type MOS transistors N10, N11, N12, N13, . . . also influence the intensity of the peak voltage Vp3 generated in the output terminal Out1 in step ST10. The intensity of the peak voltage Vp3 is determined by the ratio of the conduction impedance of the N-type MOS transistors N10 and N12 in an on-state to the conduction impedance of the P-type MOS transistor P01 in an on-state. When the conduction impedance of the N-type MOS transistors N10 and N12 located on the downstream side of a discharge current in an on-state is lower than the conduction impedance of the P-type MOS transistor P01 located on the upstream side of the discharge current in an on-state, the peak voltage Vp3 is higher. This concerns the operating speed of the N10 and N12 as described next.

While the P-type MOS transistor P01 continues to be in the on-state from step ST9 to step ST10, the N-type MOS transistors N10 and N12 change from the off-state to the on-state in the beginning of step ST10. If the operating speed of the N00 and N03 are low, the conduction impedance of the N00 and N03 is in the process of changing from the off-state to the on-state and is therefore still high when the peak voltage Vp3 is generated in the beginning of step ST10, so that the peak voltage Vp3 is low. In contrast, if the operating speed of the N00 and N03 is high, the conduction impedance of the N00 and N03 is already low when the peak voltage Vp3 is generated in the beginning of step ST10, so that the peak voltage Vp3 is higher than when the operating speed is low.

As described above, the intensity of the peak voltages Vp1, Vp2, and Vp3 changes with the intensity of the drive voltage ±Vaa, the conduction impedance of each transistor to be turned on to form a discharging path, and the operating speed of one or more transistors to be turned on later among the transistors to be turned on to form the discharging path. Thus, the intensity of the peak voltages Vp1, Vp2, and Vp3 can be controlled by controlling one or both of the conduction impedance and operating speed of each transistor.

In the meantime, the peak voltage Vp3 is highest among the peak voltages Vp1, Vp2, and Vp3. The reasons for this are as follows.

The discharge current that generates the peak voltage Vp1 separately runs through the P-type MOS transistor P00 and the P-type MOS transistor P02 on the upstream side, and runs collectively in one part of the N-type MOS transistor N11 on the downstream side. The peak voltage Vp1 is generated in the drain of each of the P-type MOS transistors P00 and P02 on the upstream side through which the discharge current separately runs. However, the discharge current is divided on the upstream side, so that the P00 and P02 can be regarded as apparently parallel in regard to the conduction impedance. Accordingly, the conduction impedance on the upstream side is equally low, so that the peak voltage Vp1 tends to be low in this respect.

The discharge current that generates the peak voltage Vp2 separately runs through the P-type MOS transistor P00 and the P-type MOS transistor P02 on the upstream side, and runs collectively in one part of the P-type MOS transistor P11 on the downstream side. The peak voltage Vp2 is generated in the drain of each of the P-type MOS transistors P00 and P02 on the upstream side through which the discharge current separately runs. However, the discharge current is divided on the upstream side, so that the P00 and P02 can be regarded as apparently parallel in regard to the conduction impedance. Accordingly, the conduction impedance on the upstream side is equally low, so that the peak voltage Vp2 tends to be low in this respect.

On the contrary, the discharge current that generates the peak voltage Vp3 is different from those that generate the Vp1 and Vp2. The discharge current that generates the peak voltage Vp3 runs collectively in one part of the P-type MOS transistor P01 on the upstream side, and separately runs through the N-type MOS transistors N10 and N12 on the downstream side. The peak voltage Vp3 is generated in the drain of the P-type MOS transistor P01 on the upstream side through which the discharge current collectively runs. The discharge current is divided on the downstream side, so that the N10 and N12 can be regarded as apparently parallel in regard to the conduction impedance. Accordingly, the conduction impedance on the downstream side is equally low, so that the peak voltage Vp3 tends to be higher than the peak voltages Vp1 and Vp2.

The peak voltage Vp2 tends to be lower than the peak voltages Vp1 and Vp3 for the following reasons. In step ST6, the Vp2 is determined by the ratio of the on-resistance of the P-type MOS transistors. Contrarily, in steps ST5 and ST10, the intensity of the Vp1 and Vp3 is determined by the ratio of the on-resistance of the N-type MOS transistor and the P-type MOS transistor. The Vp1 and Vp3 are higher in value when the conduction impedance of the N-type MOS transistor is lower and its operating speed is higher. As the N-type MOS transistor is generally higher in mobility than the P-type MOS transistor, the N-type MOS transistor is lower in conduction impedance and higher in operating speed. In this respect, the Vp1 and Vp3 tend to be higher than the Vp2, and the Vp2 tends to be lower in value.

That is, the peak voltages Vp3, Vp1, and Vp2 tend to be higher in value in this order, and the peak potentials Vp3a, Vp1a, and Vp2a tend to be higher in this order. Taking measures in this order is effective.

The peak potentials Vp1a, Vp2a, and Vp3a are higher when the drive voltage ±Vaa is higher. Therefore, if the peak voltage Vp3 can be suppressed in a condition where the drive voltage ±Vaa is high, the range of the drive voltage ±Vaa can be effectively extended.

[Measures]

Thus, in the present embodiment, the P-type MOS transistor P211 is added as the adjustment section to the buffer circuits B10, B11, B12, B13, . . . corresponding to the grounded N-type MOS transistors N10, N11, N12, N13, . . . , as described above.

The P-type MOS transistor P211 is turned on and conducted when the difference between the source voltage Vcc and the drive voltage ±Vaa is the gate ON bias. When the drive voltage ±Vaa is low, the gate ON bias of the P-type MOS transistor P211 is deep. If the gate ON bias is deep, conduction impedance Rds between the source and drain of the P-type MOS transistor P211 is low. Therefore, as indicated by (a) in FIG. 21, the rising of the voltage of the drive signal output from an output terminal Out11 is rapid. Accordingly, the conduction impedance between the drain and source of each of the N-type MOS transistors N10, N11, N12, N13, . . . that are turned on in response to this drive signal rapidly drops.

When the drive voltage ±Vaa is high, the gate ON bias of the P-type MOS transistor P211 is shallow. If the gate ON bias is shallow, the conduction impedance Rds between the source and drain of the P-type MOS transistor P211 is high. Therefore, as indicated by (b) in FIG. 21, the voltage of the drive signal output from an output terminal Out11 rises slowly and gradually. Accordingly, the conduction impedance of the N-type MOS transistors N10, N11, N12, N13, . . . that are turned on in response to this drive signal gradually drops. Thus, when the N-type MOS transistor N11 is turned on in step ST5, the conduction impedance of the N-type MOS transistor N11 is high at the beginning of a discharge. As described above, the peak voltage Vp1 generated in the output terminals Out0 and Out2 in step ST5 is determined by the ratio of the conduction impedance of the P-type MOS transistors P00 and P02 on the upstream side of the discharge current to the conduction impedance of the N-type MOS transistor N11 on the downstream side of the discharge current. Therefore, if the conduction impedance of the N-type MOS transistor N11 on the downstream side is higher at the beginning of a discharge, the peak voltage Vp1 is suppressed. As the same measures are taken for the buffer circuits B10, B11, B12, B13, . . . , the conduction impedance of the N-type MOS transistors N00 and N03 is also high at the beginning of a discharge in step ST10. As described above, the peak voltage Vp3 generated in the output terminal Out1 in step ST10 is determined by the ratio of the conduction impedance of the P-type MOS transistor P01 on the upstream side of the discharge current to the conduction impedance of the N-type MOS transistors N00 and N03 on the downstream side of the discharge current. Therefore, if the conduction impedance of the N-type MOS transistors N00 and N03 on the downstream side is higher at the beginning of a discharge, the peak voltage Vp3 is suppressed.

The peak voltage Vp2 is generated in step ST6 when the P-type MOS transistor P01 connected to the positive side of the drive voltage ±Vaa is turned on. The buffer circuit B01 corresponding to the P-type MOS transistor P01 has no adjustment section, and therefore has no effect of suppressing the peak voltage Vp2 in this embodiment. However, among the peak voltages Vp1, Vp2, and Vp3, the peak voltage Vp3 tends to be highest, and the peak voltage Vp1 tends to be second highest. Therefore, this embodiment makes it possible to effectively extend the range of the drive voltage ±Vaa by a sufficient extent.

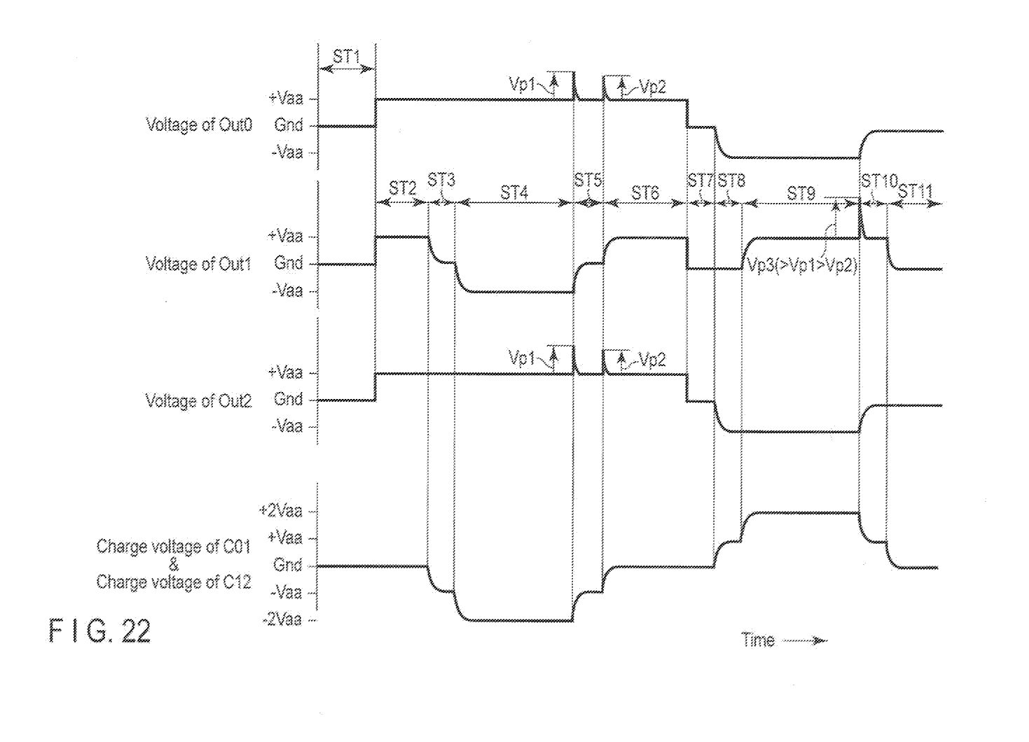

If the buffer circuit shown in FIG. 19 without the P-type MOS transistor P211 as the adjustment section is used as the buffer circuits B10, B11, B12, B13, . . . , the peak voltages Vp3, Vp1, and Vp2 are higher in this order, as shown in FIG. 22. When each of the buffer circuits B10, B11, B12, B13, . . . has the P-type MOS transistor P211 as the adjustment section, the peak voltages Vp3 and Vp1 can be decreased to be equal to or less than the peak voltage Vp2, as shown in FIG. 18.

For the optimum operation, the conduction impedance Rds between the source and drain of the P-type MOS transistor P211 as the adjustment section is preferably adjusted. A specific method for this adjustment is to adjust the size of the P-type MOS transistor P211.

As described above, the peak voltages Vp1 and Vp3 generated in steps ST5 and ST10 can be decreased. As a result, the upper limit of the range of the drive voltage ±Vaa can be raised. Thus, the actuators C01 and C12 can be driven by a wide range of voltages, and ink can be properly jetted regardless of the temperature and the viscosity of ink.

[2] A second embodiment is described.

There is another way of adjusting conduction impedance Rds between the source and drain of the P-type MOS transistor P211 as the adjustment section instead of changing the size of the P-type MOS transistor P211.

In order to increase the conduction impedance Rds, the gate voltage of the P-type MOS transistor P211 can be increased so that the gate ON bias is shallow. In contrast, in order to decrease the conduction impedance Rds, the gate voltage of the P-type MOS transistor P211 can be decreased so that the gate ON bias is deep.

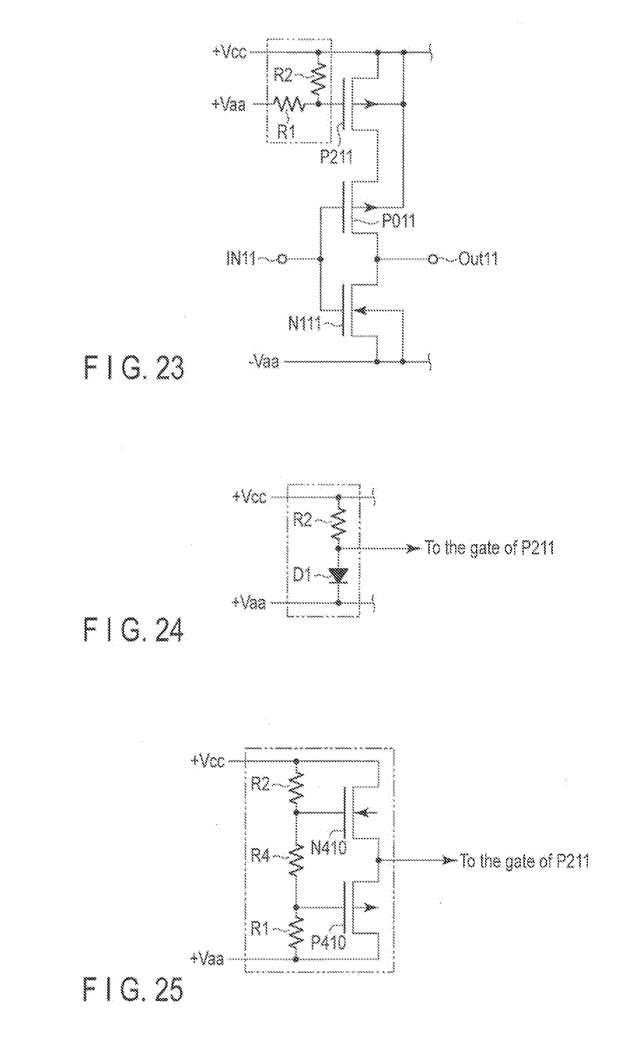

In order to increase the gate voltage, a series circuit of resistances R2 and R1 can be connected between the positive side (+Vaa) of the direct-current power source 33 and the positive side (+Vaa) of the direct-current power source 31, and an interface point of the resistances R2 and R1 can be connected to the gate of the P-type MOS transistor P211, as shown in FIG. 23. The gate voltage is adjusted in accordance with the voltage dividing ratio of the resistances R2 and R1.

As shown in FIG. 24, a constant-voltage element such as a diode D1 may be used instead of the resistance R1 in FIG. 23. If the gate voltage is adjusted by the forward voltage of the diode D1, the speed of the rising of the Vaa is more significantly decreased than when the voltage of the resistance is divided. Moreover, the impedance of a gate circuit of the P-type MOS transistor P211 decreases, and the gate voltage stabilizes. One of these methods can be suitably selected.

As shown in FIG. 25, a circuit in which a buffer comprising a voltage follower is added to the voltage dividing may be used. A series circuit of the resistances R2, R4, and R1 is connected between the positive side (+Vcc) of the direct-current power source 33 and the positive side (+Vaa) of the direct-current power source 31. A series circuit between the drain and source of an N-type MOS transistor N410 and between the source and drain of a P-type MOS transistor P410 is connected between the positive side (+Vcc) of the direct-current power source 33 and the ground. The gate of the N-type MOS transistor N410 is connected to an interface point of the resistances R2 and R4. The gate of the P-type MOS transistor P410 is connected to an interface point of the resistances R4 and R1. An interface point of the N-type MOS transistor N410 and the P-type MOS transistor P410 is connected to the gate of the P-type MOS transistor P211. In this case, the gate voltage is adjusted by the voltage dividing ratio of the resistances R2, R4, and R1 and by the voltage follower operations of the N-type MOS transistor N410 and the P-type MOS transistor P410 based on the voltage dividing ratio.

The N-type MOS transistor N410 and the P-type MOS transistor P410 are voltage followers, and function as buffer circuits. A gate voltage adjustment circuit that uses these buffer circuits more easily decreases the impedance of the gate circuit of the P-type MOS transistor P211 than a gate voltage adjustment circuit that only uses the resistance voltage dividing. Therefore, the advantage is that even when a small number of common voltage adjustment circuits are provided for a large number of actuators, the voltage adjustment circuits are not easily influenced by other circuits.

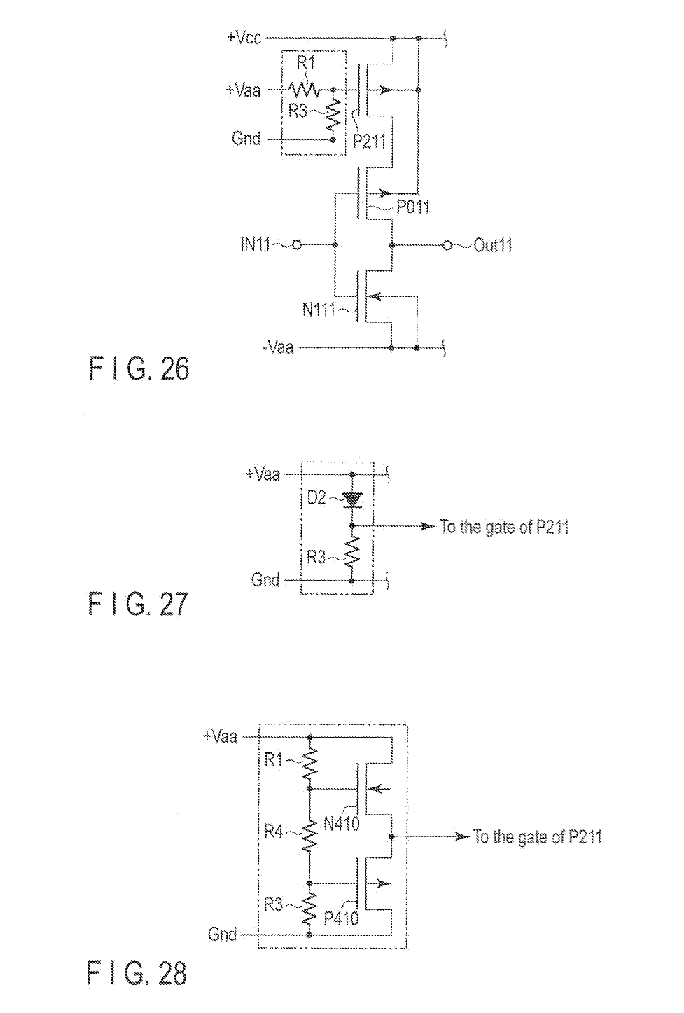

In order to decrease the gate voltage, a series circuit of the resistances R1 and R3 can be connected between the positive side (+Vaa) of the direct-current power source 31 and the ground, and an interface point of the resistances R1 and R3 can be connected to the gate of the P-type MOS transistor P211, as shown in FIG. 26. In this case, the gate voltage is adjusted in accordance with the voltage dividing ratio of the resistances R1 and R3.

As shown in FIG. 27, a constant-voltage element such as a diode D2 may be used instead of the resistance R1 in FIG. 26. If the gate voltage is adjusted by the forward voltage of the diode D2, the impedance of a gate circuit of the P-type MOS transistor P211 is lower than when the voltage of the resistance is divided, and the gate voltage stabilizes. One of these methods can be suitably selected.

As shown in FIG. 28, a circuit in which a buffer comprising a voltage follower is added to the voltage dividing may be used. A series circuit of the resistances R1, R4, and R3 is connected between the positive side (+Vaa) of the direct-current power source 31 and the ground. A series circuit between the drain and source of the N-type MOS transistor N410 and between the source and drain of the P-type MOS transistor P410 is connected between the positive side (+Vaa) of the direct-current power source 31 and the ground. The gate of the N-type MOS transistor N410 is connected to an interface point of the resistances R1 and R4. The gate of the P-type MOS transistor P410 is connected to an interface point of the resistances R4 and R3. An interface point of the N-type MOS transistor N410 and the P-type MOS transistor P410 is connected to the gate of the P-type MOS transistor P211. In this case, the gate voltage is adjusted by the voltage dividing ratio of the resistances R1, R4, and R3 and by the voltage follower operations of the N-type MOS transistor N410 and the P-type MOS transistor P410 based on the voltage dividing ratio.

The configuration is the same as that in the first embodiment in other respects.

[3] A third embodiment is described.

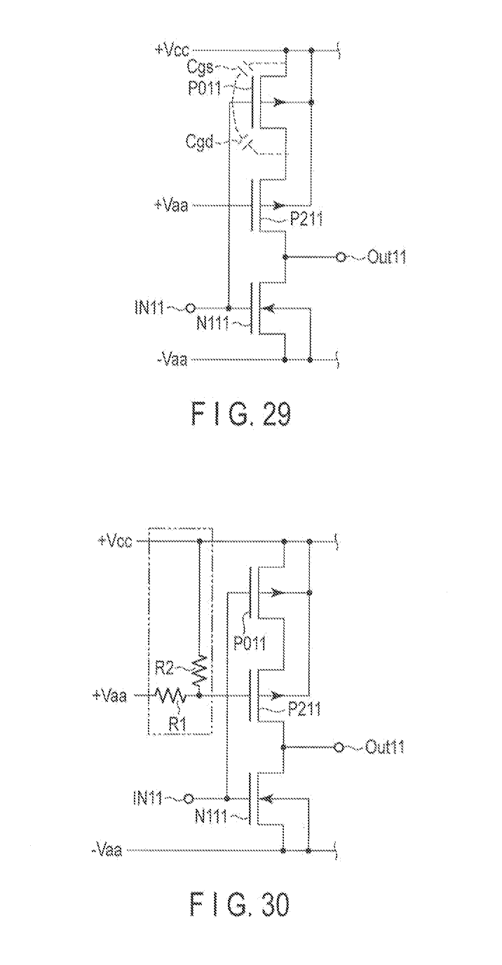

The buffer circuits B10, B11, B12, B13, . . . having the configuration shown in FIG. 29 may be used instead of the buffer circuits B10, B11, B12, B13, . . . shown in FIG. 20. That is, as the P-type MOS transistors P211 and P011 have only to be connected in series with each other, the P-type MOS transistors P211 and P011 are connected in reversed orientations in the buffer circuits B10, B11, B12, B13, . . . shown in FIG. 29. In this case, there is no negative feedback from a point A to an input terminal IN11 by a capacitance Cgs between the gate and source of the P-type MOS transistor P001 shown in FIG. 20, so that a negative feedback from the output terminal Out11 to the input terminal IN11 by a capacitance Cgd between the gate and drain of the P-type MOS transistor P011 also decreases. The advantage is therefore that the input impedance rises and the load on the previous stage of this circuit is lessened accordingly.

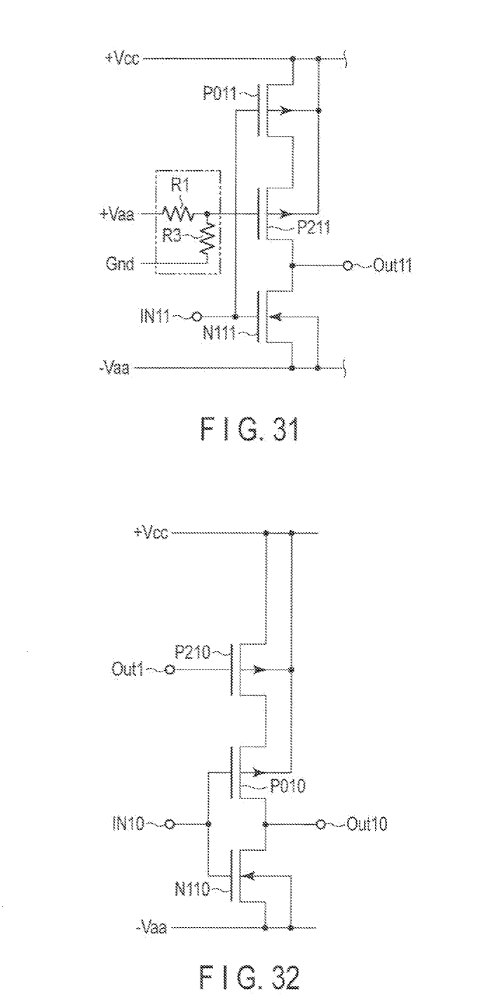

As shown in FIG. 30, the same gate voltage adjustment circuit as that shown in FIG. 23 may be used as means for adjusting the conduction impedance Rds between the gate and drain of the P-type MOS transistor P211 which is the adjustment section. As shown in FIG. 31, the same gate voltage adjustment circuit as that shown in FIG. 26 may otherwise be used. Several modifications described in the second embodiment are also applicable to the third embodiment.

The configuration is the same as that in the first embodiment in other respects.

[4] A fourth embodiment is described.

A buffer circuit shown in FIG. 32 may be used instead of the buffer circuit shown in FIG. 20. FIG. 32 shows an example of the buffer circuit B10 corresponding to the N-type MOS transistor N10. That is, the buffer circuit B10 connects, between the positive side (+Vcc) of the direct-current power source 33 and the negative side (−Vaa) of the direct-current power source 32, a series circuit between the source and drain of a P-type MOS transistor P210 which is an adjustment section, between the source and drain of a P-type MOS transistor P010, and between the drain and source of an N-type MOS transistor N110. The back gates of the P-type MOS transistors P010 and P210 are connected to the positive side (+Vaa) of the direct-current power source 33. The back gate of the N-type MOS transistor N110 is connected to the negative side (−Vaa) of the direct-current power source 32. The gate of the P-type MOS transistor P010 and the gate of the N-type MOS transistor N110 are used as an input terminal IN10. The control signal supplied from the controller 50 is brought into the input terminal IN10. An interface point of the P-type MOS transistor P010 and the N-type MOS transistor N110 is used as an output terminal Out10, and a drive signal is output from the output terminal Out10. Moreover, the gate of the P-type MOS transistor P210 as the adjustment section is connected to the output terminal Out1 of the adjacent channel.

In the buffer circuit shown in FIG. 20, the gate of the P-type MOS transistor which is the-adjustment section is connected to the positive side (+Vaa) of the direct-current power source 31 to monitor the drive voltage Vaa. In the buffer circuit shown in FIG. 32, the gate of the P-type MOS transistor which is the adjustment section is connected to a terminal that faces across the capacitive load C01, that is, the output terminal Out1 of the adjacent channel to directly detect the peak voltage Vp3. That is, if the peak voltage Vp3 generated in step ST10 is high in step ST10, the gate voltage of the P-type MOS transistor P210 which is the adjustment section rises, and the gate ON bias of the P-type MOS transistor P210 becomes shallow. As a result, the conduction impedance of the P210 increases, so that the initial output voltage of the OUT10 decreases, and its rising becomes slower. As a result, the conduction impedance of the N10 is initially high, and decreases with time. That is, the on-operation of the N10 becomes slower. As a result, a feedback that suppresses the peak voltage Vp3 takes effect. Each of the buffer circuits B11, B12, B13, . . . also monitors the output terminal of the adjacent channel in the same manner.

In the buffer circuit B11, if the peak voltage Vp1 generated in the output terminal Out2 in step ST5 is high, the gate voltage of the P-type MOS transistor which is the adjustment section rises, the gate ON bias of this P-type MOS transistor becomes shallow, and a feedback that suppresses the peak voltage Vp1 generated in the output terminals Out0 and Out2 takes effect. In step ST10 where ink is jetted from a nozzle 12 corresponding to the output terminal Out2, that is, where the output terminal Out2 is mainly driven, the peak voltage Vp3 generated in the output terminal Out2 can be suppressed as in the operation of the buffer circuit B10 for driving the output terminal Out1. The same applies to the buffer circuits B12, B13, . . . .

The configuration is the same as that in the first embodiment in other respects.

[5] A fifth embodiment is described.

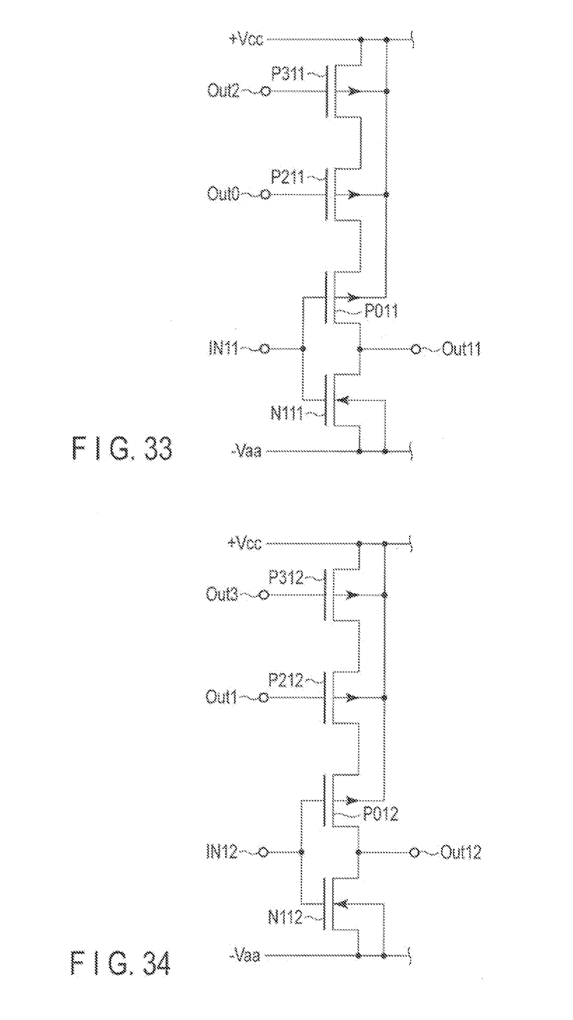

A buffer circuit shown in FIG. 33 is used instead of the buffer circuit shown in FIG. 20. In this case, the peak voltages of the adjacent channels are monitored, which is more effective.

FIG. 33 shows the example of buffer circuit B11 corresponding to the N-type MOS transistor N11.

That is, the buffer circuit B11 comprises two P-type MOS transistors P211 and P311 which are adjustment sections in addition to the basic configuration shown in FIG. 19. The P-type MOS transistors P211 and P311 are inserted and connected in series between the positive side (+Vaa) of the direct-current power source 33 and a series circuit of the P-type MOS transistor P011 and the N-type MOS transistor N111. The gates of the P-type MOS transistors P211 and P311 are connected to the positive side (+Vaa) of the direct-current power source 31. The gates of the P-type MOS transistors P211 and P311 are then connected to terminals that face across the capacitive loads C01 and C12, that is, the output terminals Out0 and Out2.

The buffer circuits B12, B13, . . . are configured in the same manner. The buffer circuit B12 has a configuration shown in FIG. 34. The buffer circuit B10 only has one adjacent channel, and therefore uses the configuration shown in FIG. 32.

In the buffer circuit shown in FIG. 33, the gates of the two P-type MOS transistors which are adjustment sections are connected to the output terminals Out0 and Out2, respectively. Thus, the peak voltages Vp1 and Vp2 are directly detected. In step ST5 where ink is jetted from the nozzle 11 corresponding to the output terminal Out1, that is, where the output terminal Out1 is mainly driven, the gate voltages of the two P-type MOS transistors which are adjustment sections rise, the gate ON biases of these P-type MOS transistors become shallow, and a feedback that suppresses the peak voltage Vp1 takes effect, if the peak voltage Vp1 generated in the output terminals Out0 and Out2 is high. In step ST10 where ink is jetted from the nozzle 12 corresponding to the output terminal Out2, that is, where the output terminal Out2 is mainly driven, the peak voltage Vp3 generated in the output terminals Out2 can be suppressed in a similar manner. When the output terminal Out2 is mainly driven, the buffer circuit B13 operates in a manner similar to the buffer circuit B11, so that the effect of suppressing the peak voltage Vp3 is higher than in the buffer circuit shown in FIG. 32.

The P-type MOS transistors P311 and P211 shown in FIG. 33 have only to be connected in series with each other, and may therefore be connected in reversed orientations. The same applies to P-type MOS transistors P312 and P212 shown in FIG. 34.

The configuration is the same as that in the first embodiment in other respects.

[6] A sixth embodiment is described.

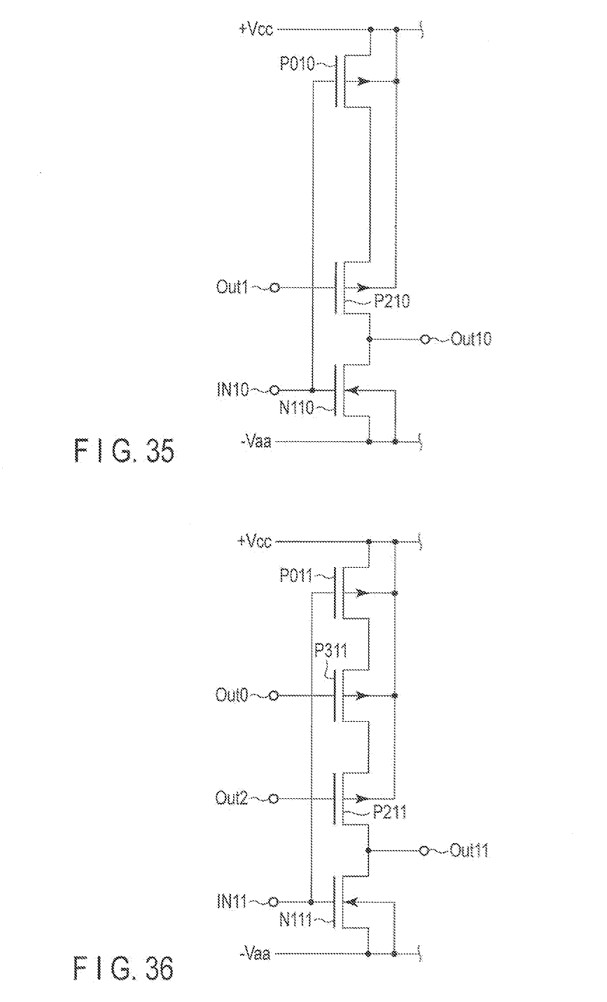

A buffer circuit having a configuration shown in FIG. 35 may be used instead of the buffer circuit shown in FIG. 32. As the P-type MOS transistors P210 and P010 have only to be connected in series with each other, the P-type MOS transistors P210 and P010 are connected in reversed orientations in the buffer circuit shown in FIG. 35.

The configuration is the same as that in the first embodiment in other respects.

[7] A seventh embodiment is described.

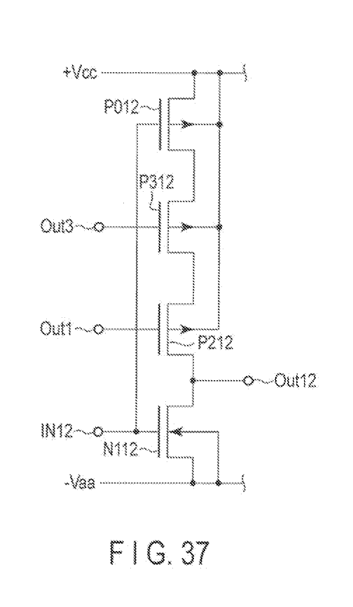

A buffer circuit having a configuration shown in FIG. 36 may be used instead of the buffer circuit shown in FIG. 33. As the P-type MOS transistors P312, P212, and P012 have only to be connected in series with one other, the P-type MOS transistors P312, P212, and P012 are connected in reversed orientations in the buffer circuit shown in FIG. 36. The same applies to the buffer circuits B12, B13, . . . . The buffer circuit B12 has a configuration shown in FIG. 37.

The configuration is the same as that in the first embodiment in other respects.

[8] While the MOS transistors are used as the semiconductor elements in the embodiments described above, any other elements having similar functions may be used instead of the MOS transistors.

The polarity of, for example, the voltage in the embodiments described above may be inverted. For example, similar operations and advantageous effects can be provided even if all the P-type MOS transistors are replaced with N-type MOS transistors, all the N-type MOS transistors are replaced with P-type MOS transistors, and the polarities of the direct-current power sources and the actuators are inverted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drive circuit of a capacitive load comprising:
a direct-current power source which outputs a direct-current voltage necessary to charge and discharge the capacitive load;
switches which are connected between the direct-current power source and the capacitive load and which form a conduction path to charge and discharge the capacitive load; and
an adjustment section which adjusts an impedance of at least one of the switches that are turned on to discharge a charge stored in the capacitive load back to the direct-current power source.

2. The circuit of claim 1, wherein
the switches that are turned on for the discharge are turned on in order, and
the at least one of the switches is a switch that is turned on later.

3. The circuit of claim 1, wherein
the at least one of the switches is a switch that is located on the downstream side of a discharge current running during the discharge.

4. The circuit of claim 1, wherein
the switches are semiconductor elements, and
the adjustment section adjusts the conduction impedance of at least one of the semiconductor elements that are turned on to discharge a charge stored in the capacitive load back to the direct-current power source.

5. The circuit of claim 4, wherein
the adjustment section gradually decreases the conduction impedance of the at least one of the semiconductor elements when an output voltage of the direct-current power source is high, and the adjustment section rapidly decreases the conduction impedance when the output voltage is low.

6. The circuit of claim 4, wherein
the adjustment section adjusts the conduction impedance of the at least one of the semiconductor elements so that the conduction impedance becomes higher in accordance with an increase in a voltage of a terminal that faces across the capacitive load.

7. The circuit of claim 4, further comprising:
buffer circuits which output drive signals to selectively turn on and off the semiconductor elements.

8. The circuit of claim 7, wherein
the adjustment section is disposed in one of the buffer circuits that corresponds to the at least one of the semiconductor elements, and the adjustment section gradually changes the voltage of the drive signal output to turn on the at least one of the semiconductor elements when an output voltage of the direct-current power source is high, and the adjustment section rapidly changes the voltage when the output voltage is low.

9. The circuit of claim 7, wherein
the adjustment section is disposed in one of the buffer circuits that corresponds to the at least one of the semiconductor elements, and the adjustment section adjusts the voltage of the drive signal output to turn on the at least one of the semiconductor elements so that the voltage of the drive signal becomes lower in accordance with an increase in a voltage of a terminal that faces across the capacitive load.

10. A drive circuit of a capacitive load comprising:
a first direct-current power source and a second direct-current power source which are connected in series with each other so that an interface point therebetween is grounded, the first direct-current power source outputting a direct-current voltage Vaa to the ground, the second direct-current power source outputting, to the ground, a direct-current voltage −Vaa opposite in polarity to the first direct-current power source;
a third direct-current power source which is grounded and which outputs a direct-current voltage Vcc, the direct-current voltage Vcc being equal in polarity to the first direct-current power source and being high in value;
a first switch circuit which comprises a series circuit of a first MOS semiconductor element and a second MOS semiconductor element, and a third MOS semiconductor element, the series circuit of the first MOS semiconductor element and the second MOS semiconductor element being connected between a side of the first direct-current power source to output the direct-current voltage Vaa and the ground, the third MOS semiconductor element being connected between an interface point of the first MOS semiconductor element and the second MOS semiconductor element and a side of the second direct-current power source to output the direct-current voltage −Vaa,
a back gate of the first MOS semiconductor element being connected to a side of the third direct-current power source to output the direct-current voltage Vcc, an interface point of the first MOS semiconductor element, the second MOS semiconductor element, and the third MOS semiconductor element being connected to one end of the capacitive load as an output terminal;
a second switch circuit which comprises a series circuit of a fourth MOS semiconductor element and a fifth MOS semiconductor element, and a sixth MOS semiconductor element, the series circuit of the fourth MOS semiconductor element and the fifth MOS semiconductor element being connected between the side of the first direct-current power source to output the direct-current voltage Vaa and the ground, the sixth MOS semiconductor element being connected between an interface point of the fourth MOS semiconductor element and the fifth MOS semiconductor element and the side of the second direct-current power source to output the direct-current voltage −Vaa,
a back gate of the fourth MOS semiconductor element being connected to the side of the third direct-current power source to output the direct-current voltage Vcc, an interface point of the fourth MOS semiconductor element, the fifth MOS semiconductor element, and the sixth MOS semiconductor element being connected to the other end of the capacitive load as an output terminal;
buffer circuits which supply gates of the semiconductor elements with output drive signals to selectively turn on and off the semiconductor elements; and
adjustment sections respectively disposed in the buffer circuits corresponding to the second and fifth MOS semiconductor elements among the buffer circuits, the adjustment sections adjusting voltages of the drive signals output to turn on the corresponding second and fifth MOS semiconductor elements.

11. The circuit of claim 10, wherein
the adjustment sections slow down the rising of the drive signals output to turn on the second and fifth MOS semiconductor elements when the output voltage Vaa of the first direct-current power source is high, and the adjustment sections speed up the rising of the drive signals when the output voltage Vaa is low.

12. The circuit of claim 11, wherein
the buffer circuits comprise at least three MOS semiconductor elements connected in series, at least one of these MOS semiconductor elements constituting the adjustment sections and being controlled so that the conduction impedance thereof becomes higher in accordance with an increase in the output voltage Vaa of the first direct-current power source.

13. The circuit of claim 10, wherein
the adjustment sections adjust voltages of the drive signals output to turn on the second and fifth MOS semiconductor elements so that the voltages of the drive signals become lower in accordance with an increase in a voltage of a terminal that faces across the capacitive load.

14. The circuit of claim 11, wherein
the buffer circuits comprise at least three MOS semiconductor elements connected in series, at least one of these MOS semiconductor elements constituting the adjustment sections and being controlled so that the conduction impedance thereof becomes higher in accordance with an increase in the voltage of the terminal that faces across the capacitive load.

15. The circuit of claim 10, wherein
two capacitive loads are provided, and the capacitive loads are connected on one end to the same first switch circuit and being respectively connected on the other end to two independent second switch circuits.

16. The circuit of claim 15, wherein
the adjustment sections adjust voltages of the drive signals output to turn on the second MOS semiconductor element and the two fifth MOS semiconductor elements so that the voltages of the drive signals are low when a voltage of a terminal that faces across the capacitive loads is high.

17. The circuit of claim 16, wherein
the buffer circuits comprise at least four MOS semiconductor elements connected in series, at least two of these MOS semiconductor elements constituting the adjustment sections and being controlled so that the conduction impedance thereof becomes higher in accordance with an increase in the voltage of the terminal that faces across the capacitive loads.

18. A drive circuit of an inkjet head which jets ink when a capacitive actuator is charged and discharged, the drive circuit comprising:
a direct-current power source which outputs a direct-current voltage necessary to charge and discharge the capacitive actuator;
switches which are connected between the direct-current power source and the capacitive actuator and which form a conduction path to charge and discharge the capacitive actuator; and
an adjustment section which adjusts the impedance of at least one of the switches that are turned on to discharge a charge stored in the capacitive actuator back to the direct-current power source.

19. The circuit of claim 18, wherein
the switches that are turned on for the discharge are turned on in order, and
the at least one of the switches is a switch that is turned on later.

20. The circuit of claim 18, wherein
the at least one of the switches is a switch that is located on the downstream side of a discharge current running during the discharge.

21. The circuit of claim 18, wherein
the switches are semiconductor elements, and
the adjustment section gradually decreases the conduction impedance of at least one of the semiconductor elements that are turned on to discharge the charge stored in the capacitive actuator back to the direct-current power source when an output voltage of the direct-current power source is high, and the adjustment section rapidly decreases the conduction impedance when the output voltage is low.
